(19) United States
(12) Patent Application Publication
(10) Pub. No.: US 2011/0104340 A1
(43) Pub. Date: May 5, 2011

(54) POWDERED COMPOSITION CONTAINING OIL-SOLUBLE COMPONENT, FUNCTIONAL FOOD USING THE SAME, AND PACKAGED PRODUCT THEREOF

(75) Inventors: Keiichi Suzuki, Kanagawa (JP); Hidemi Sasaki, Kanagawa (JP); Shinichiro Serizawa, Kanagawa (JP); Jun Arakawa, Kanagawa (JP)

(73) Assignee: FUJIFILM CORPORATION, Minato-ku, Tokyo (JP)

(21) Appl. No.: 12/673,977

(22) PCT Filed: Aug. 19, 2008
(86) PCT No.: PCT/JP2008/065061

§ 371 Date: Feb. 18, 2010

(30) Foreign Application Priority Data
Aug. 20, 2007 (JP) 2007-213712
Sep. 5, 2007 (JP) 2007-230582

(51) Int. Cl. A21D 2/16; A23L 2/52

(52) U.S. Cl. 426/96; 426/654; 426/590

(57) ABSTRACT

To provide an powdered composition containing an oil-soluble component useful for functional foods, suppressing stickiness on the surface of powders, reducing powder-aggregation and being produced in high yield and upon dispersion in an aqueous medium, stably forming finely emulsified particles of 150 nm or less, as well as a packaged powdered composition storable for a long period without aggregating the powder or denaturing the component;

A powdered composition obtained by drying an emulsion composition containing an oil-soluble component and an emulsifier, wherein the melting point of the emulsifier is 45° C. or more, and the ratio of the emulsifier to the oil-soluble component is 0.5 to 1.5, as well as a packaged powdered composition comprising the same sealed in a packaging material having an oxygen transmission rate of 50 mL/m²/atm/day or less and a moisture transmission degree of 40 g/m²/day or less in the presence of a deoxidant and a desiccant.

### BACKGROUND

1. Technical Field

The present invention relates to a powdered composition containing an oil-soluble component, obtained by drying an emulsion composition and a food containing the powdered composition and in particular to a powdered composition stably containing an oil-soluble component, which can be dissolved and dispersed in an aqueous medium to give an emulsified product having finely emulsified particles and to a functional food using the same. The invention also relates to a packaged product suitable for storage of a powdered composition having a specific water content and excellent in re-dispersibility in an aqueous medium, represented by the powdered composition mentioned above.

2. Background Art

In recent years, attention has been focused on the functionality of oil-soluble components in carotenoids and unsaturated fatty acids, and many compositions containing them have been developed. Upon using such oil-soluble components as the active ingredient in foods or cosmetics, the products are desirably used as emulsified products wherein emulsified particles are as small as possible, from the viewpoint of the outward appearance and palatability of the products or the ability of the functional oil-soluble components to be absorbed into the skin or digestive organs.

As a base material for using an oil-soluble component with an emulsified product, a powdered composition which, upon dispersion in an aqueous medium based on water, can form a finely emulsified dispersion is used from the viewpoint of excellent stability and transportability.

Such a powdered composition excellent in re-solubility and re-dispersibility and capable forming a preferable emulsified product is prepared by first dispersing an oil-soluble component in an aqueous medium uniformly with an emulsifier to prepare an emulsion composition and then drying it.

When the content of a functional oil-soluble component is increased to attempt to improve functionality, the surface of powders containing the oil-soluble component becomes sticky when the oil-soluble component is increased, easily causing aggregation. In the process of drying an emulsion composition, a spray drying step, wherein the emulsion composition is sprayed and simultaneously dried, is generally used, but when powders having a sticky surface are formed in this step, a phenomenon occurs in which the powders aggregate or adhere to an internal wall of a drying device, reducing the yield, and when a powdered composition containing such aggregates is dissolved and dispersed in an aqueous medium, the particle size of the resulting emulsified particles is increased, thus making it difficult to acquire a desired emulsified product.

When the powders in the resulting powdered composition have a sticky surface, there arises a further problem of deterioration of workability upon encapsulating the powders or forming the powders into tablets.

Techniques disclosed in stabilizing the emulsification of an oil-soluble component include, for example, a technique wherein a surfactant consisting of an ester or ether of a predetermined sugar, which is solid at a temperature of 45° C. or less, is used and such an emulsifier is added at a ratio of 2 to 10 to an oil-soluble component to give a nanoemulsion (see, for example, Japanese Patent No. 3583331). However, the nanoemulsion produced by this technique is still not satisfactory from the viewpoint of emulsification stability, and the powderization of the emulsion composition is not considered at all therein.

Further, techniques disclosed in dispersing carotenoids that are oil-soluble functional pigments in water include, for example, a technique wherein edible fats, fat-soluble vitamins and the like are added in carotenoids as solubilizing agents or dispersants (see, for example, Japanese Patent Application Laid-Open No. 2000-106844).

The above discloses that 30 to 99 parts by mass amount of an emulsifier which is a solid or a liquid at room temperature includes 1 part of carotenoids. However, it is difficult to obtain a stable composition comprising a sufficient amount of carotenoids by this technique. Although the purpose of this composition is, as in the present invention, to provide a carotenoid water dispersion without a powdered composition, the problems involved in powderization are not considered at all therein.

Products containing an active ingredient or an oil component in an emulsified state in foods or cosmetics are widely used, and in production thereof, a powdered composition which can form a finely emulsified dispersion upon dispersion in an aqueous medium based on water is used from the viewpoint of excellent stability and transportability.

Such a powdered composition, which is excellent in re-solubility and re-dispersibility, capable of forming preferable emulsified products, and which has a predetermined water content in order to maintain these characteristics, suffers from a problem of solidification of their powders during storage in a packaged product where they are hermetically packaged, and are liable to be influenced by ambient humidity so that the powders are made sticky due to, for example, high humidity, and adhere to one another and aggregate, thus causing a problem of deterioration with respect to re-solubility and re-dispersibility, and therefore, there has been desire for a hermetically packaged product having long-term storage durability.

Particularly, when a component easily denatured with oxygen is included in the powdered composition, it is desirable that the packaging material used has excellent oxygen blocking properties, and also that the inside of the packaged product is a non-oxygen atmosphere, in order to prevent denaturation of its contents. For these purposes, techniques including a method wherein the contents are enclosed by vacuum packaging by a packaging article formed from a transparent material including a composite film having specific oxygen blocking properties as a constituent unit, a method of enclosing a deoxidant, and a method of gas flush packaging have been proposed (Japanese Patent Application Laid-Open (JP-A) No. 2006-27638).

Denaturation with oxygen can be inhibited by these methods, but they require special facilities for vacuum packaging or gas flush packaging and are difficult to apply to powdered compositions. Preferably, a deoxidant is coexistent, but a standard deoxidant will retain a predetermined amount of water by a process of oxygen adsorption, giving rise to a new problem of sticky powders due to this water.

### DISCLOSURE OF THE INVENTION

The present invention provides a powdered composition containing oil-soluble component useful for functional foods etc., which can suppress stickiness on the surface of powders upon powderization, can reduce the aggregation of the powders and the amount of the powders adhered to an apparatus in a production process, can be produced in high yield, can, upon dissolution and dispersion in an aqueous medium, give an emulsified product capable of stably forming finely emulsified particles of 150 nm or less, as well as a packaged powdered composition which can be stored for a long period of time without aggregating the powdered composition or denaturing the functional oil-soluble component. A first aspect of the invention relates to an powdered composition containing an oil-soluble component obtained by drying an emulsion composition containing an oil-soluble component and an emulsifier, wherein the melting point of the emulsifier is 45° C. or more, and the ratio of the emulsifier to the oil-soluble component is 0.5 to 1.5. Another aspect of the invention relates to a packaged powdered composition containing an oil-soluble component comprising the powdered composition sealed in a packaging material having an oxygen transmission rate of 50 mL/m²/atm/day or less and a moisture transmission degree of 40 g/m²/day or less in the presence of a deoxidant and a desiccant.

### Problems to be solved by the Invention

An object of the invention made in consideration of the problems described above is to provide an powdered composition containing an oil-soluble component obtained by drying an emulsion composition containing a functional oil-soluble component, which can suppress stickiness on the surface of powders upon powderization, can reduce the aggregation of the powders and the amount of the powders adhering to an apparatus in a production process, and can be produced in high yield and an powdered composition containing an oil-soluble component which contains a sufficient amount of a functional oil-soluble component and can, upon dissolution and dispersion in an aqueous medium, give an emulsified product capable of stably forming finely emulsified particles of 150 nm or less.

Another object of the invention is to provide a functional food containing the functional oil-soluble component as finely emulsified particles and making the functional oil-soluble component excellent in absorbability, which is produced from an powdered composition containing an oil-soluble component containing a sufficient amount of the functional oil-soluble component and giving an emulsified product capable of stably forming finely emulsified particles. Still another object is to provide a packaged powdered composition wherein a powdered composition that contains an oil component containing at least one functional oil component and can, upon addition to an aqueous medium, form an emulsified dispersion can be stored for a long time stably without aggregating powders or denaturizing the functional oil component.

### Means for Solving the Problems

The inventors made extensive study, and as a result, they found that the physical properties of an emulsifier and the amounts of an oil-soluble component and emulsifier added are regulated, and a powdered composition is sealed in the presence of a deoxidant and a desiccant, with a packaging material having specified oxygen barrier properties, thereby achieving the objects of the invention, and the invention was thereby completed.

That is, the constitution of the invention is as follows:

<1>. An powdered composition containing an oil-soluble component obtained by drying an emulsion composition containing an oil-soluble component and an emulsifier, wherein the melting point of the emulsifier is 45° C. or more, and the ratio of the emulsifier to the oil-soluble component is 0.5 to 1.5.
<2>. The powdered composition containing an oil-soluble component of item <1>, wherein the emulsifier having a melting point of 45° C. or more is included as the emulsifier at an amount of 60% by mass or more with respect to the total amount of the emulsifier.
<3>. The powdered composition containing an oil-soluble component of item <2>, wherein the emulsifier is a sucrose fatty acid ester and/or a polyglycerin fatty acid ester.
<4>. The powdered composition containing an oil-soluble component of item <1>, wherein the emulsifier comprises (b) a sucrose fatty acid ester and/or a polyglycerin fatty acid ester and (c) a phospholipid, and the ratio of (b) to (c) in the composition is established such that (b) is equal to, or higher than, (c).
<5>. The powdered composition containing an oil-soluble component of item <4>, wherein the phospholipid includes two fatty acid residues in one molecule thereof.
<6>. The powdered composition containing an oil-soluble component of item <4>, further comprising (d) an excipient.
<7>. The powdered composition containing an oil-soluble component of any one of items <1> to <6>, wherein the oil-soluble component is at least one member selected from the group consisting of carotenoids and unsaturated fatty acids.
<8>. The powdered composition containing an oil-soluble component of any one of items <1> to <7>, wherein at least one member selected from the group consisting of tocopherol, tocotrienol and derivatives thereof is further included as the oil-soluble component.
<9>. The powdered composition containing an oil-soluble component of any one of items <1> to <8>, wherein the emulsified particle size of an emulsified product obtained by dissolving and dispersing the powdered composition containing an oil-soluble component in an aqueous medium is 150 nm or less.
<10>. A functional food comprising the powdered composition containing an oil-soluble component of any one of items <1> to <9>.
<11>. The functional food of item <10>, which is in the dosage form of a drink, a capsulated product, granules or tablets.
<12>. A packaged powdered composition containing an oil-soluble component comprising the powdered composition containing an oil-soluble component of any one of items <1> to <9> enclosed in a packaging material having an oxygen transmission rate of 50 mL/m²/atm/day or less and a moisture transmission degree of 40 g/m²/day or less in the presence of a deoxidant and a desiccant.
<13>. The packaged powdered composition containing an oil-soluble component of item <12>, wherein the packaging material is selected from a single-layer or multilayer resin film, a metal foil-laminated resin film and a metal-deposited film.
<14>. The packaged powdered composition containing an oil-soluble component of item <12>, wherein the powdered composition containing an oil-soluble component is enclosed in a breathable film.
<15>. The packaged powdered composition containing an oil-soluble component of item <12>, wherein the powdered composition containing an oil-soluble component satisfies:
i) the water content thereof is 0.5% to 3.0%, and
ii) the average particle size of emulsified particles in an emulsion composition obtained by converting the powdered composition into 1 mass % aqueous solution is in the range of from 1 nm to less than 130 nm.

The powdered composition containing an oil-soluble component of the invention can prevent the reduction in yield attributable to the stickiness of powders in the production process and can also inhibit the increase, attributable to undesired aggregates, in the particle size of emulsified particles in an emulsified product obtained by re-dispersing the powdered composition. The powdered composition containing an oil-soluble component of the invention is excellent in processability, and the size of emulsified particles in an emulsified product obtained by dissolving and dispersing the powered composition in an aqueous medium is as small as 150 nm or less.

When the powdered composition containing an oil-soluble component of the invention is used in foods, the foods contain such finely emulsified particles stably, thereby attaining excellent absorption of the functional oil-soluble component into the living body, and thus the composition of the invention exhibits an excellent effect by application to functional foods. According to the invention, the powdered composition can be stored with a low water content and can, even during storage in a high-humidity atmosphere, prevent stickiness on powders in the composition and suppress the aggregation, attributable to such stickiness, of the powders, thus making the particle size excellent in stability with time. There is also an advantage that even if a component poor in light resistance, such as a pigment, is stored as the functional oil component, the pigment is excellent in stability with no change with time in its absorbance at spectral absorption maximum.

### BEST MODE FOR CARRYING OUT THE INVENTION

### Powdered Composition Containing an Oil-Soluble Component

The powdered composition containing an oil-soluble component in the first aspect of the invention is a powdered composition obtained by drying an emulsion composition containing an oil-soluble component and an emulsifier, wherein the melting point of the emulsifier is 45° C. or more, and the ratio of the emulsifier to the oil-soluble component is 0.5 to 1.5.

By using the emulsifier having a melting point of 45° C. or more and simultaneously by regulating the content of the emulsifier relative to the oil-soluble component, the resulting composition can effectively prevent the stickiness on powders attributable to the oil-soluble component.

The second aspect of the invention is characterized in that a powdered composition obtained by drying an emulsion composition comprising (a) an oil component containing at least one functional oil component, (b) a sucrose fatty acid ester and/or a polyglycerin fatty acid ester and (c) a phospholipid, wherein the ratio of (b) to (c) in the composition is established such that (b) is equal to or higher than (c), is enclosed in a packaging material having an oxygen transmission rate of 50 mL/m²/atm/day or less and a moisture transmission degree of 40 g/m²/day or less in the presence of a deoxidant and a desiccant.

The third aspect of the invention is characterized in that as the powdered composition described above, a powdered composition satisfying that i) the water content is 0.5% to 3.0% and ii) the average particle size of emulsified particles in an emulsion composition obtained by converting the powdered composition into 1 mass % aqueous solution is in the range of from 1 nm to less than 130 nm is enclosed in a packaging material having an oxygen transmission rate of 50 mL/m²/atm/day or less and a moisture transmission degree of 40 g/m²/day or less in the presence of a deoxidant and a desiccant.

In both the second and third aspects, the powdered composition that is an enclosed material to be packaged with the packaging article of the invention contains a functional oil component and can, upon addition to an aqueous medium, be easily dissolved and dispersed to give a stable emulsified product having finely emulsified particles.

Hereinafter, the respective components included in the powdered composition of the invention are described in detail.

<Emulsifier having a Melting Point of 45° C. or More>

The emulsifier having a melting point of 45° C. or more is used in the present invention. The emulsifier usable in the invention preferably has a melting point of 45° C. or more, more preferably a melting point of 47° C. or more, still more preferably 50° C. or more, from the viewpoint of improving the yield. The upper limit of the melting point is not particularly limited, but from the viewpoint of handleability in consideration of the fact that the manufacturing temperature of an emulsion composition is typically 60 to 70° C., the melting point is preferably 70° C. or less, more preferably 60° C. or less.

The specific examples of the emulsifier that can be preferably used in the invention include a sucrose fatty acid esters or a polyglycerin fatty acid ester.

The sucrose fatty acid ester used in the invention has 12 or more carbon atoms in the fatty acid moiety thereof, more preferably 12 to 20 carbon atoms, from the viewpoint of surface activity and melting point. By using the ester having 12 or more carbon atoms in the fatty acid moiety, the melting point can be maintained in a preferable range, and emulsion particles of smaller average particle size can be formed.

The emulsifier having a melting point of 45° C. or more is included preferably in an amount of 60% by mass or more, more preferably 70% by mass or more, still more preferably 75% by mass or more, with respect to the total amount of the emulsifier, from the viewpoint of suitably maintaining the size of emulsified particles in an emulsified product obtained by dissolving and dispersing the powdered composition in an aqueous medium.

The sucrose fatty acid ester preferably has 12 or more carbon atoms in the fatty acid moiety, more preferably 12 to 20 carbon atoms, from the viewpoint of surface activity. By using the ester having 12 or more carbon atoms in the fatty acid moiety, emulsion particles of smaller average particle size may be formed.

Specific examples of the sucrose fatty acid ester include sucrose oleic acid diester, sucrose stearic acid diester, sucrose palmitic acid diester, sucrose myristic acid diester, sucrose lauric acid diester, sucrose oleic acid monoester, sucrose stearic acid monoester, sucrose palmitc acid monoester, sucrose myristic acid monoester and sucrose lauric acid monoester. Of those, a sucrose fatty acid monoester is more preferred, and particularly sucrose lauric acid monoester and sucrose oleic acid monoester are preferred.

In the invention, those sucrose fatty acid esters can be used alone or as mixtures thereof.

Examples that may be given of suitable commercially available product of the sucrose fatty acid ester include RYOTO-sugar ester S-070, S-170, S-270, S-370, S-370F, S-570, S-770, S-970, S-1170, S-1170F, S-1570, S-1670, P-070, P-170, P-1570, P-1670, M-1695, O-170, O-1570, OWA-1570, L-195, L-595, L-1695, LWA-1570, B-370, B-370F, ER-190, ER-290 and POS-135, products of Mitsubishi-Kagaku Foods Corporation; DK ester SS, F160, F140, F110, F90, F70, F50, F-A50, F-20W, F-10 and F-ALOE, and COSMELIKE B-30, S-10, S-50, S-70, S-110, S-160, S-190, SA-10, SA-50, P-10, P-160, M-160, L-10, L-50, L-160, L-150A, L-160A, R-10, R-20, O-10 and O-150, products of Daiichi-Kogyo Seiyaku Co., Ltd.

Among above, the sucrose fatty acid ester as the emulsifier having a melting point of 45° C. or more is enumerated below together with its melting point (peak value shown in round brackets), but the invention is not limited thereto.

Sucrose stearic acid ester (56° C.), sucrose palmitic acid ester (48° C.), sucrose myristic acid ester (47° C.), sucrose lauric acid ester (47° C.), sucrose monostearic acid ester (52° C.), sucrose monopalmitic acid ester (45° C.).

Among them, sucrose lauric acid ester (47° C.), sucrose monopalmitic acid ester (45° C.), sucrose monostearic acid ester (52° C.) are more preferable. In the invention, these sucrose fatty acid esters can be used singly or as a mixture thereof.

Examples of preferable commercially available products that may be used as the sucrose fatty acid ester in the invention include RYOTO-sugar esters S-1170, S-1570, S-1670, P-1570, P-1670 and L-1695, and monoester-P, products of Mitsubishi-Kagaku Foods Corporation; and DK esters SS, F-160, F-140, F-110, and F-90, products of Dai-ichi Kogyo Seiyaku Co., Ltd.

The polyglycerin fatty acid ester used in the invention is an ester of a polyglycerin having an average degree of polymerization of 2 or more, preferably from 6 to 15, and more preferably from 8 to 10, and a fatty acid having from 8 to 18 carbon atoms such as caprylic acid, capric acid, lauric acid, myristic acid, palmitic acid, stearic acid, oleic acid and linoleic acid. Preferred examples of the polyglycerin fatty acid ester include hexaglycerin monooleic acid ester, hexaglycerin monostearic acid ester, hexaglycerin monopalmitic acid ester, hexaglycerin monomyristic acid ester, hexaglycerin monolauric acid ester, decaglycerin monooleic acid ester, decaglycerin monostearic acid ester, decaglycerin monopalmitic acid ester, decaglycerin monomyristic acid ester and decaglycerin monolauric acid ester.

Of those, decaglycerin monooleic acid ester (HLB=12), decaglycerin monostearic acid ester (HLB=12), decaglycerin monopalmitic acid ester (HLB=13), decaglycerin monomyristic acid ester (HLB=14) and decaglycerin monolauric acid ester (HLB=16) are more preferred.

Those polyglycerin fatty acid esters can be used alone or as mixtures thereof.

Examples that may be given of suitable commercially available products include NIKKOL DGMS, NIKKOL DGMO-CV, NIKKOL DGMO-90V, NIKKOL DGDO, NIKKOL DGMIS, NIKKOL DGTIS, NIKKOL Tetraglyn 1-SV, NIKKOL Tetraglyn 1-O, NIKKOL Tetraglyn 3-S, NIKKOL Tetraglyn 5-S, NIKKOL Tetraglyn 5-O, NIKKOL Hexaglyn 1-L, NIKKOL Hexaglyn 1-M, NIKKOL Hexaglyn 1-SV, NIKKOL Hexaglyn 1-O, NIKKOL Hexaglyn 3-S, NIKKOL Hexaglyn 4-B, NIKKOL Hexaglyn 5-S, NIKKOL Hexaglyn 5-O, NIKKOL Hexaglyn PR-15, NIKKOL Decaglyn 1-L, NIKKOL Decaglyn 1-M, NIKKOL Decaglyn 1-SV, NIKKOL Decaglyn 1-50SV, NIKKOL Decaglyn 1-ISV, NIKKOL Decaglyn 1-O, NIKKOL Decaglyn 1-OV, NIKKOL Decaglyn 1-LN, NIKKOL Decaglyn 2-SV, NIKKOL Decaglyn 2-ISV, NIKKOL Decaglyn 3-SV, NIKKOL Decaglyn 3-OV, NIKKOL Decaglyn 5-SV, NIKKOL Decaglyn 5-HS, NIKKOL Decaglyn 5-IS, NIKKOL Decaglyn 5-OV, NIKKOL Decaglyn 5-O-R, NIKKOL Decaglyn 7-S, NIKKOL Decaglyn 7-O, NIKKOL Decaglyn 10-SV, NIKKOL Decaglyn 10-IS, NIKKOL Decaglyn 10-OV, NIKKOL Decaglyn 10-MAC and NIKKOL Decaglyn PR-20, products of Nikko Chemicals Co., Ltd.; RYOTO-polyglyester L-7D, L-10D, M-10D, P-8D, SWA-10D, SWA-15D, SWA-20D, S-24D, S-28D, O-15D, O-50D, B-70D, B-100D, ER-60D, LOP-120DP, DSI13W, DS3, HS11, HS9, TS4, TS2, DL15 and DO13, products of Mitsubishi-Kagaku Foods Corporation; SUNSOFT Q-17UL, SUNSOFT Q-14S and SUNSOFT A-141C, products of Taiyo Kagaku Co., Ltd.; and POEM DO-100 and POEM J-0021, products of Riken Vitamin Co., Ltd.

Among above, specific examples of the polyglycerin fatty acid ester having a melting point of 45° C. or more include an ester of a polyglycerin having an average degree of polymerization of 2 or more, preferably from 6 to 15, and more preferably from 8 to 10, and a fatty acid having from 8 to 18 carbon atoms such as caprylic acid, capric acid, lauric acid, myristic acid, palmitic acid, stearic acid, oleic acid and linoleic acid. More preferable examples of the polyglycerin fatty acid ester having a melting point of 45° C. or more include hexaglycerin stearic acid ester (about 50° C.), tetraglycerin stearic acid ester (about 52° C.), decaglycerin stearic acid ester (about 50° C.) and decaglycerin behenic acid ester (71° C.).

More preferable among these polyglycerin fatty acid esters are decaglycerin stearic acid ester (HLB=12), decaglycerin palmitic acid ester (HLB=13) etc.

These polyglycerin fatty acid esters having a melting point of 45° C. or more may be used singly or as a mixture thereof in combination with the sucrose fatty acid ester having a melting point of 45° C. or more.

A polyglycerin ester that is in a viscous liquid state at ordinary temperature has a melting point of less than 45° C., but may be used in combination with the sucrose fatty acid ester having a melting point of 45° C. or more as long as the effect of the invention is not impaired, and the polyglycerin ester can be preferably simultaneously used for example in an amount of less than 40% by mass with respect to the sucrose fatty acid ester.

Preferable commercially available products include, for example, RYOTO-polyglyesters HS11, HS9, TS4, TS2, S24D and PBD, products of Mitsubishi-Kagaku Foods Corporation; and NIKKOL Decaglyn 1-SV, Tetraglyn 1-SV and Hexaglyn 1-SV, products of Nikko Chemicals Co., Ltd.

Either the sucrose fatty acid ester or the polyglycerin fatty acid ester may be included in the powdered composition of the invention, but both of them are used preferably from the viewpoint of further improving the storage stability of powders.

These sucrose fatty acid esters and polyglycerin fatty acid esters are preferably those having an HLB value of 8 or more, more preferably 10 or more, still more preferably 12 or more. The upper limit of the HLB value is not particularly limited, but is generally 18 or less, preferably 17 or less.

The HLB used herein is the balance of hydrophilicity-hydrophobicity generally used in the field of surfactants, and a generally used calculation formula g, such as Kawakami's calculation formula, can be used. The invention employs the following Kawakami's calculation formula.

HLB=7+11.7log(M_{w}+Mₒ)

wherein M_{w} is the molecular weight of the hydrophilic group, and Mₒ is the molecular weight of the hydrophobic group.

HLB values described in brochures and the like may be used.

As is apparent from the above formula, a surfactant having an optional HLB value can be obtained by utilizing additive properties of HLB.

In the invention, an emulsifier having a melting point of less than 45° C. may be simultaneously used as long as the effect of the invention is not impaired.

As a preferable emulsifier in the invention, the sucrose fatty acid ester having a melting point of 45° C. or more is included in an amount of 60% by mass or more of the whole of the emulsifier, and insofar as this condition is satisfied, an emulsifier having a melting point of 45° C. or less, or an emulsifier other than the sucrose fatty acid ester having a melting point of 45° C. or more may be simultaneously used in an amount of up to 40% by mass.

The emulsifier having a melting point of less than 45° C. includes, for example, the polyglycerin ester in a viscous liquid state at ordinary temperature, a mixture of sucrose fatty acid esters dissolved in ethanol, and unsaturated fatty acid sucrose esters.

The powdered composition of the invention can contain these components as the component (b) in an amount of preferably 1% by mass to 50% by mass, more preferably 5% by mass to 40% by mass, with respect to the whole of the powdered composition. When these components are simultaneously used, the mass ratio of the sucrose fatty acid ester to the polyglycerin fatty acid ester is not particularly limited, but is preferably 10:90 to 90:10, from the viewpoint of improving the storage stability of the powders.

The content of the sucrose fatty acid ester in the invention is preferably 0.1 to 40% by mass, more preferably 1 to 30% by mass, still more preferably 5 to 20% by mass, with respect to the emulsion composition. By making the content 0.1% by mass or more, an emulsion composition of fine particles can be effectively obtained, and excellent emulsification stability can be maintained even if polyphenols are added, and by making the content 40% by mass or less, the foaming of the emulsion composition can be suitably suppressed.

When another emulsifier is simultaneously used, the total amount of another emulsifier and the sucrose fatty acid ester may be in the range defined above, and in this case, the content of another emulsifier is preferably 50% by mass or less, more preferably 30% by mass or less, with respect to the total amount of the emulsifier, in order to secure the effect of the invention.

In the invention, the emulsifier contains (b) a sucrose fatty acid ester and/or a polyglycerin fatty acid ester and (c) a phospholipid, wherein the ratio of (b) to (c) in the composition is preferably established such that (b) is equal to, or higher than, (c).

Simultaneously usable emulsifiers other than the sucrose fatty acid ester and polyglycerin fatty acid ester in the preferable mode include phospholipids.

As used herein, phospholipids refer to esters which among complex lipids, consist of a fatty acid, an alcohol, phosphoric acid and a nitrogen compound, are one group having phosphoric acid esters and fatty acid esters, and refer to glycerol-free glycerophospholipids and sphingosine-containing sphingophospholipids.

The phospholipids that can be used in the invention include, for example, glycerolecithins such as lecithin (phosphatidylcholine), phosphatidic acid, bisphosphatidic acid, phosphatidyl ethanolamine, phosphatidyl methylethanolamine, phosphatidyl serine, phosphatidyl inositol, phosphatidyl glycerin, and diphosphatidyl glycerin (cardiolipin); and sphingolecithins such as sphingomyelin. Other examples include various lecithins derived from plants containing these components, such as soybeans, corns, peanuts, rapeseeds and oats, lecithins derived from animals such as yolks and cattle, and lecithins derived from microorganisms such as Escherichia coli. The origins of these phospholipids are not particularly limited, but purified ones are particularly preferable. In the invention, these phospholipids may be used alone or in combination.

Among these phospholipids, lecithin (phosphatidylcholine) is preferable from the viewpoint of easy availability, safety, and emulsifiability.

In the invention, the glycerophospholipid includes a glycerophospholipid that as a result of enzymatic digestion, has one fatty acid residue in one molecule, that is, lysolecithin.

Lysolecithin is obtained by hydrolysis of lecithin in the presence of an acid or alkali catalyst, but can also be obtained by hydrolysis of lecithin using phospholipase A₁ or A₂. Examples of the lysolecithin include lisophosphatidic acid, lysophosphatidylglycerin, lysophosphatidylinositol, lysophosphatidylethanolamine, lysophosphatidylmethylethanolamine, lysophosphatidylcholine (lysolecithin) and lysophosphatidylserine.

Lecithin has a hydrophilic group and a hydrophobic group in the molecule, and is therefore conventionally widely used as an emulsifier in the fields of foodstuff, medicines and cosmetics.

Industrially, lecithin with a purity of 60% or more is utilized as lecithin and is also utilizable in the invention, but from the viewpoint of formation of fine oil droplets and stability of lipid-soluble substance, high-purity lecithin having a lecithin purity of 80 mass % or more, preferably 90 mass % or more, is generally preferable.

The lecithin purity (% by mass) is obtained by subtracting the weights of toluene-insoluble substances and acetone-soluble substances, utilizing the property that lecithin tends to dissolve in toluene and does not dissolve in acetone.

High purity lecithin has high lipophilicity as compared with lysolecithin, and it is therefore preferable, as compatibility between lecithin and an oil-based component is increased, thereby improving emulsion stability. The phospholipid used in the invention can be used alone or as mixtures of two or more thereof.

Lecithin include various kinds of known lecithins extracted and separated from living bodies of plants, animals and microorganisms. Commercial products of lecithin include Lecion series and Lecimale EL manufactured by Riken Vitamin Co., Ltd.

Besides the high-purity lecithin, hydrogenated lecithin, enzymatically decomposed lecithin, enzymatically decomposed hydrogenated lecithin, hydroxy lecithin etc. may be used in the invention.

Hydrogenation can be carried out by, for example, reacting lecithin with hydrogen in the presence of a catalyst, thereby the unsaturated bond in the fatty acid moiety is hydrogenated. The hydrogenation improves oxidation stability of lecithin.

The enzymatically decomposed lecithin is also called lysolecithin and has hydrophilicity increased by allowing phospholipase A2 to act on lecithin to hydrolyze an ester linkage at the β-position thereby increasing hydroxyl groups.

Hydroxylation is where unsaturated bond(s) in the fatty acid moiety are hydroxylated by heating lecithin together with high concentration of hydrogen peroxide and an organic acid such as acetic acid, tartaric acid or butyric acid. Hydroxylation improves the hydrophilicity of lecithin.

These phospholipids that can be used in the invention can be used singly or in the form of a mixture of two or more thereof.

When the phospholipid is simultaneously used as an emulsifier in the powdered composition in the invention, its content is preferably 0.1 to 10% by mass, more preferably 0.2 to 8% by mass, more preferably 0.5 to 5% by mass.

By regulating the content of the phospholipid in the range defined above, the emulsification stability of the emulsion composition is made excellent and prevents an excess of the phospholipid from being separated from the oil component, thus suppressing formation of a phospholipid dispersing element, which is preferable for the emulsification stability of the emulsion composition.

In the powdered composition of the invention, the emulsifier having a melting point of 45° C. or more is used in such an amount that the ratio of the whole emulsifier containing the emulsifier having a melting point of 45° C. or more to the oil-soluble component described later is in the range of 0.5 to 1.5. From the viewpoint of suitably maintaining the size of emulsified particles in an emulsified product obtained by dissolving and dispersing the powdered composition in an aqueous medium, the ratio of the two is preferably in the range of 0.6 to 1.4, more preferably 0.5 to 1.2.

In the powdered composition of the invention, the ratio of the component (b) to the component (c) in the composition is established such that the component (b) is equal to, or higher than, the component (c). Because the component (b) is present in an amount equal to, or higher than, the component (c), a smaller particle size can be attained, and simultaneously the storage stability of the particle size and the storage stability of the emulsion can also be made excellent.

The ratio of the component (b) to the component (c) in the composition is established such that the ratio of the component (b) to the component (c) is preferably in the range of 1 to 100, more preferably from 5 to 80, from the viewpoint of a suitable amount for finer particles and for emulsification stability and from the viewpoint of regulating foaming upon forming the powdered composition into an emulsion composition.

The powdered composition usable in the invention may also contain other surfactants mentioned below, in addition to the components (b) and (c). The surfactant in the invention is preferably a nonionic surfactant (hydrophilic surfactant) dissolving in an aqueous medium because it can significantly reduce the interfacial tension in the oil phase/water phase in the emulsion composition, resulting in making the particle size smaller.

Examples of nonionic surfactants usable in the invention include polyglycerin fatty acid ester, organic acid monoglyceride, propylene glycol fatty acid ester, polyglycerin condensed licinoleic acid ester, sorbitan fatty acid ester and polyoxyethylene sorbitan fatty acid ester. Of those, sorbitan fatty acid ester and polyoxyethylene sorbitan fatty acid ester are preferred. The surfactant is not always required to be a surfactant that is highly purified, by distillation or the like, and may be a reaction mixture.

The sorbitan fatty acid ester used in the invention has preferably 8 or more carbon atoms, and more preferably 12 or more carbon atoms, in the fatty acid moiety. Preferred examples of the sorbitan fatty acid ester include sorbitan monocaprylate, sorbitan monolaurate, sorbitan monostearate, sorbitan sesquistearate, sorbitan tristearate, sorbitan isotearate, sorbitan sesquiisostearate, sorbitan oleate, sorbitan sesquioleate and sorbitan trioleate.

Those sorbitan fatty acid esters can be used alone or as mixtures thereof.

Examples that may be given of suitable commercially available products of the sorbitan fatty acid ester include NIKKOL SL-10, SP-10V, SS-10V, SS-10MV, SS-15V, SS-30V, SI-10RV, SI-15RV, SO-10V, SO-15MV, SO-15V, SO-30V, SO-10R, SO-15R, SO-30R and SO-15EX, products of Nikko Chemicals Co., Ltd.; SORGEN 30V, 40V, 50V, 90 AND 110, products of Daiichi-Kogyo Seiyaku Co., Ltd.; and REODOL AS-1W, AO-10V, AO-15V, SP-L10, SP-P10, SP-S10V, SP-S30V, SP-010V and SP-030V, products of Kao Corporation.

The polyoxyethylene sorbitan fatty acid ester used in the invention has preferably 8 or more, and more preferably 12 or more, carbon atoms in the fatty acid moiety. Furthermore, the length (number of moles added) of ethylene oxide of the polyethylene is preferably from 2 to 100, and more preferably from 4 to 50.

Preferred examples of the polyoxyethylene sorbitan fatty acid ester include polyoxyethylene sorbitan caprylic acid monoester, polyoxyethylene sorbitan lauric acid monoester, polyoxyethylene sorbitan stearic acid monoester, polyoxyethylene sorbitan stearic acid sesquiester, polyoxyethylene sorbitan stearic acid triester, polyoxyethylene sorbitan isostearic acid ester, polyoxyethylene sorbitan isostearic acid sesquiester, polyoxyethylene sorbitan oleic acid ester, polyoxyethylene sorbitan oleic acid sesquiester and polyoxyethylene sorbitan oleic acid triester.

Those polyoxyethylene sorbitan fatty acid esters can be use alone or as mixtures thereof.

Examples that may be given of suitable commercially available products of the polyoxyethylene sorbitan fatty acid ester include NIKKOL TL-10, NIKKOL TP-10V, NIKKOL TS-10V, NIKKOL TS-10MV, NIKKOL TS-106V, NIKKOL TS-30V, NIKKOL TI-10V, NIKKOL TO-1W, NIKKOL TO-10MV, NIKKOL TO-106V and NIKKOL TO-30V, products of Nikko Chemicals Co., Ltd.; REODOL TW-L106, TW-L120, TW-P120, TW-S106V, TW-S120V, TW-S320V, TW-0106V, TW-0120V, TW-0320V and TW-IS399C, and REODOL SUPER SP-L10 and TW-L120, products of Kao Corporation; and SORGEN TW-20, TW-60V and TW-80V, products of Daiichi-Kogyo Seiyaku Co., Ltd.

The amount of these other surfactants is preferably 0.5 part by mass or less, more preferably 2 parts by mass or less, still more preferably 1.5 parts by mass or less, further more preferably 1 part by mass or less, per part of the oil component. The surfactant in an amount of 2 parts by mass or less is preferable for tendency to prevent problems such as severe foaming.

The amount of these arbitrary surfactants is preferably 0.01 to 30% by mass, more preferably 0.1 to 20% by mass, still more preferably 1 to 15% by mass, with respect to the whole of the powdered composition.

By making the amount of the surfactant 0.01% by mass or more, the powdered composition when formed into an emulsion composition can easily reduce the interfacial tension in the oil phase/water phase, and by making the amount 30% by mass or less, the emulsion composition hardly causes problems such as severe foaming in the absence of an excess of the surfactant.

(d) Excipient

From the viewpoint of easy powderization, the powdered composition of the invention preferably contains an excipient as the component (d).

The excipient may be a water-soluble substance generally used for stabilizing and granulating the oil component in the powdered composition, and examples of the excipient includes monosaccharides and polysaccharides such as glucose, fructose, lactose, maltose, sucrose, dextrin, maltodextrin, cyclodextrin, maltose, fructose, inulin and trehalose; sugar alcohols such as sorbitol, mannitol, maltitol, lactose, maltotriitol and xylitol; inorganic salts such as sodium chloride and sodium sulfate; polysaccharide thickeners such as gum arabic, guar gum, pectin, pullulan and sodium alginate; cellulose derivatives such as methyl cellulose and carboxymethylcellulose sodium; starch derivatives obtained by esterifying or etherifying starch or reducing its terminal; other modified starch, gelatin decomposition products, agar, and polyvinyl alcohol. Among them, the filters are preferably monosaccharides, polysaccharides, sugar alcohols and inorganic salts from the viewpoint of solubility, more preferably gum arabic, inulin, dextrin, sugar alcohols and inorganic salts from the viewpoint of hygroscopicity and particle formability, still more preferably gum arabic, inulin and dextrin, most preferably inulin. These excipients may be used singly or in combination of two or thereof.

From the viewpoint of efficiently and excellently maintaining the oil component, these excipients are used preferably in an amount of 20% by mass to 95% by mass, more preferably 30% by mass to 85% by mass, with respect to the whole of the powdered composition.

If necessary, other additives may suitably added to the powdered composition of the invention, but from the viewpoint of easy powderization, it is preferable that polyhydric alcohols that are liquid at ordinary temperature are not included. As used herein, the polyhydric alcohols refer to dihydric or more alcohols such as glycerin, diglycerin, triglycerin, polyglycerin, 3-methyl-1,3-butanediol, 1,3-butylene glycol, isoprene glycol, 1,2-pentanediol, 1,2-hexanediol, propylene glycol, dipropylene glycol, polypropylene glycol, ethylene glycol, diethylene glycol, pentaerythritol and neopentyl glycol, and these polyhydric alcohols may be used alone or in the form of a mixture of two or more thereof.

In the invention, the phrase “polyhydric alcohols that are liquid at ordinary temperature are not included” means that the content of the polyhydric alcohols is 1% by mass or less, preferably 0.5% by mass or less, more preferably 0.1% by mass or less, most preferably 0% by mass, with respect to the whole of the powdered composition.

<Oil-Soluble Component>

The oil component in the invention is an oil component containing at least one functional oil component. The functional oil component in the invention refers to oil components showing useful effects when used in foods, cosmetics and pharmaceutical preparations and refers, from chemical structure, to fats and oils, hydrocarbons, waxes, esters, fatty acids, higher alcohols, polymers, oil-soluble pigments, and oil-soluble proteins. The functional oil components include, but are not limited to, mixtures thereof, that is, various plant-derived oils and animal-derived oils.

From the viewpoint of functions, the functional oil component includes, but is not limited to, a UV absorber, an antioxidant, an anti-inflammatory agent, a humectant, a hair-protecting agent, a dispersant, a solvent, a skin-whitening agent, an anti-wrinkle agent, cellular stimulant, an emollient agent, a keratolytic agent, an antistatic agent, vitamins, a metabolic syndrome-ameliorating agent, an antihypertensive agent, an analgesic agent, and functional foods.

A preferable example of the functional oil component used in the invention is at least one member selected from carotenoids (carotenoid pigments), fat-soluble vitamins and fat-soluble vitamin-like substances, and examples thereof includes carotenoids, fat-soluble vitamins, ubiquinones, unsaturated fatty acids, and fats and oils.

From the viewpoint of a smaller size of emulsified particles and emulsification stability, the content of these oil-soluble components in the invention is preferably 0.1 to 30% by mass, more preferably 1 to 20% by mass, still more preferably 5 to 15% by mass, with respect to the emulsion composition for obtaining the powdered composition.

When carotenoids, fat-soluble vitamins, ubiquinones, ω-3 fats and oils, particularly carotenoids that are oil-soluble functional pigments, are applied to the invention, the powdered composition having a significant effect of high transparency upon dispersion in water and excellent storage stability can be obtained in the invention.

Preferable examples of the carotenoids in the invention include carotenoids including natural pigments, and these pigments are yellow to red pigments of terpenoids including those of plants, algae and bacteria.

The carotenoids are not limited to naturally derived carotenoids, and any carotenoids obtained by a usual manner are included in the carotenoids referred to in the invention. For example, many of commercial β-carotenes have been produced by synthesis.

Carotenoids include hydrocarbons (carotenes) and their oxidized alcohol derivatives (xanthophylls).

Examples of such compounds include actinioerythrol, astaxanthin, bixin, canthaxanthin, capxanthin, capsorbin, β-8′-apo-carotenal (apocarotenal), β-12′-apo-carotenal, α-carotene, β-carotene, “Carotene” (mixture of α- and β-carotenes), γ-carotene, β-cryptoxanthin, exenone, lutein, lycopene, bioretorin (phonetic), zeaxanthin, and hydroxyl- or carboxyl-containing esters thereof.

Many caroteniods are naturally present in the form of cis- and trans-isomers, but synthesized products are often a racemic mixture. Carotenoids can generally be extracted from plant materials. Those carotenoids have various functions. For example, lutein extracted from petal of calendula is widely used as a raw material of poultry feed, and has the function of coloring poultry skin and fat, and poultry eggs.

From the viewpoint of rendering emulsified particles fine, the carotenoids used in the invention are preferably oily at ordinary temperature. In a particularly preferable aspect, the powdered composition may contain at least one member selected from astaxanthin and astaxanthin derivatives such as esters, having an antioxidant effect, an anti-inflammatory effect, an anti-aging effect on skin, and a skin-whitening effect and being known as coloring matters in the range of yellow to red (hereinafter, referred to collectively as “astaxanthins”).

From the viewpoint of odor, these astaxanthins are more preferably those extracted from natural materials with a supercritical carbon dioxide gas.

Astaxanthin is a red pigment having absorption maximum at 476 nm (ethanol) and 468 nm (hexane), and belongs to exanthophylls as one kind of carotenoid (Davies, B. H.: In “Chemistry and Biochemistry of Plant Pigments”, T. W. Goodwin ed., 2nd ed., 38-165, Academic Press, NY, 1976). The chemical structure of astaxanthin is 3,3′-dihydroxy-β,β-carotene-4,4′-dione (C₄₀H₅₂O₄, molecular weight 596.82).

In the astaxanthin, three isomers of 3S,3S′-form, 3S,3R′-form (meso form) and 3R,3R′-form are present depending on a steric configurations of hydroxyl groups at 3 (3′)-position of a ring structure present at both ends of the molecule. Additionally, cis- and trans-isomers of a conjugated double bond at the molecular center are present. For example, there are all cis- and 9-cis and 13-cis forms of isomer.

The hydroxyl group at a 3(3′)-position can form an ester with fatty acid. Astaxanthin obtained from Euphausiacea are 3S,3S′-form when obtained from a diester having two fatty acids bonded thereto (Yamaguchi, K., Miki, W., Toriu, N., Kondo, Y., Murakami, M., Konosu, S., Satake, M., and Fujita, T.: The composition of carotenoid pigments in the antrarctic krill Euphausia superba, Bull. Jap. Sos. Sci. Fish., 1983, 49, p. 1411-1415), H. pluvialis, and a large amount of a monoester having one fatty acid bonded thereto is included (Renstrom, B., Liaaen-Jensen, S.: Fatty acids of some estrified carotenols, Comp. Biochem. Physiol. B, Comp. Biochem., 1981, 69, p. 625-627).

Furthermore, astaxanthin obtained from Rhaffia Rhodozyma is 3R,3R′-form (Andrewes, A. G., Starr, M. P.: (3R,3′R)-Astraxanthin from the yeast Phaffarhodozyma, Phytochem., 1976, 15, p. 1009-1011), and has a structure opposite 3S,3S′-form generally found naturally. This is present in a free form which does not form an ester with fatty acid (Andrewes, A. G., Phaffia, H. J., Starr, M. P.: Carotenids of Phaffia rhodozyma, a red pigmented fermenting yeast, Phytochem., 1976, 15, p. 1003-100′7).

Astaxanthin and its ester form were first separated from a lobster (Astacus gammarus L.) by Kuhn et al., and its estimated structure was disclosed (Kuhn, R., Soerensen, N. A.: The coloring matters of the lobster (Astracus gammarus L.), Z. Angew. Chem., 1938, 51, p. 465-466). Since then, it has been clarified that astaxanthin is widely distributed in nature, is generally present as in the astaxanthin fatty acid ester form, and is also present as astaxanthin protein (ovorubin and crustacyanin) bonded to protein in crustacean (Cheesman, D. F.: Ovorubin, a chromoprotein from the eggs of the gastropod mollusc Pomacea canaliculata, Proc. Roy. Soc. B, 1958, 149, p. 571-587).

The astaxanthin and its ester (astaxanthins) may be included in the emulsion composition of the invention as an astaxanthin-containing oil separated and extracted from natural products containing astaxanthin and/or containing an astaxanthin ester. Examples of such an astaxanthin-containing oil include extracts obtained by culturing red yeast Phaffia, green alga Haematococcus, marine bacteria or the like and extracting from its culture, and extracts from antactic Euphausiacea and the like.

It is known that Haematococcus alga extract (Haematococcus alga-derived pigment) differs from Euphausiacea-derived pigment and synthesized astaxanthin in the kind ester and its content.

Astaxanthins that can be used in the invention may be the above-described extracts, products by appropriate purification of those extracts according to need, and synthetic products. Astaxanthins that are particularly preferably, from the point of view of quality and productivity, are products extracted from Haematococcus alga (hereinafter, it may be called Haematococcus alga extracts).

Specific examples that may be given of products derived from Haematococcus alga extract that can be used in the invention include Haematococcus pluvialis, Haematococcus lacustris, Haematococcus capensis, Haematococcus droebakensis and Haematococcus zimbabwiensis. Various methods may be employed at the culture method of Haematococcus alga that can be used in the invention such as disclosed in, for example, JP-A-8-103288, the method is not particularly limited, as long as the form is changed from that of a vegetative cell to that of a cyst cell as dormant cell.

Haematococcus alga extracts that can be used in the invention are obtained by crushing, as required, cell walls of the above raw materials by a method described in, for example, JP-A No. 5-68585 and adding an extracting solvent such as an organic solvent such as acetone, ether, chloroform and alcohol (ethanol, methanol and the like), or carbon dioxide in a supercritical state, followed by extraction.

In the invention, commercially available Haematococcus alga extracts can be used, and examples thereof include ASTOTS-S, ASTOTS-2.5 O, ASTOTS-5 O and ASTOTS-10 O, products of Takedashiki Co., Ltd.; AstaREAL oil 50F and AstaREAL oil 5F, products of Fuji Chemical Industry Co., Ltd.; and BioAstin SCE7, a product of Toyo Koso Kagaku Co., Ltd.

The content of the astaxanthins as a pigment pure component in Haematococcus alga extracts that can be used in the invention is preferably from 0.001% to 50% by mass, and more preferably from 0.01% to 25% by mass, from the standpoint of an extraction cost.

Haematococcus alga extracts that can be used in the invention contain astaxanthin or its ester as a pigment pure component similar to the pigment described in JP-A-2-49091, and contain the ester in an amount of generally 50% by mole or more, preferably 75% by mole or more, and more preferably 90% by mole or more.

Further detailed explanation is described in internet (URL:http://www.astraxanthin.co.jp/chemical/basic.htm), 2005.

These astaxanthins are more preferably those extracted from natural materials with a supercritical carbon dioxide gas, from the viewpoint of its odor in a powder form.

Ubiquinones include coenzyme Q etc. such as coenzyme Q10. Coenzyme Q10 is one kind of coenzyme described as “Ubidecanolene” in Japanese Pharmacopoeia, and is also called ubiquinone 10, coenzyme UQ10 etc. Coenzyme Q10 was approved and marketed in 1974 in Japan as a medical pharmaceutical of a metabolic cardiotonic. Thereafter, coenzyme Q10 has been handled as pharmaceuticals including OTC (over-the-counter drug). Overseas (mainly in Europe and the United States), on one hand, the demand thereof as a highly effective and safe health food material is increasing. According to “Amendment to Standards on the Scope of Pharmaceuticals” (Pharmaceutical Announcement No. 243) noticed by Chief of Pharmaceutical and Food Safety Bureau in Ministry of Health, Labour and Welfare, Japan, coenzyme Q10 is listed in “Ingredient Substances (base Materials) Recognized as Foods Unless Pharmaceutical Effect Efficacy are Advocated”, to ease the regulation so that coenzyme Q10 may be handled as food in Japan as well. Various functionalities possessed by this food material attract attention in Japan too, and many general foods (so-called health foods) containing coenzyme Q10 are being commercialized. In the natural world, coenzyme Q10 is included in natural products such as yeasts, mackerels, sardines and wheat germs and can be extracted with solvents such as hot water, water-containing alcohol, and acetone. It can also be industrially produced, and its fermentation process and synthesis process are generally known. Coenzyme Q10 used in the invention may be extracted from natural products or may be industrially synthesized. As coenzyme Q10, a commercial product may be used, and examples of the commercial product include coenzyme Q10 coenzyme produced by Nisshin Pharma and coenzyme Q10 powder manufactured by NOF Corporation

For utilizing the functions of coenzyme Q10, the water-solubilization of this material as a fat-soluble substance is important. The object of this water-solubilization is to secure the absorbability thereof in the living body anytime upon ingestion by ameliorating an estimated disadvantage that the absorbability of the fat-soluble substance in the living body is low unless it is ingested with another food at a meal. These products may be used singly or in combination thereof.

The fat-soluble vitamins include fat-soluble vitamin E, retinoids, vitamin D, and oil-solubilized derivatives of ascorbic acid and erythorbic acid, among which fat-soluble vitamin E that has a high antioxidant function and can also be used as a radical scavenger is preferable.

The fat-soluble vitamin E includes, but is not limited to, tocopherol, tocotrienol, and derivatives thereof, for example tocopherol and derivatives thereof such as dl-α-tocopherol, dl-β-tocopherol, dl-γ-tocopherol, dl-6-tocopherol, dl-α-tocopherol acetate, dl-α-tocopherol nicotinate, dl-α-tocopherol linoleate and dl-α-tocopherol succinate, as well as α-tocotrienol, β-tocotrienol, γ-tocotrienol and δ-tocotrienol. These vitamins may be used singly or in combination thereof, but are preferably used in the form of a mixture, and the mixture includes a tocopherol extract and mixed tocopherol.

Examples of the retinoids include retinol, 3-hydroretinol, retinal, 3-hydroretinal, retinoic acid, 3-dehydroretinoic acid, vitamin A such as vitamin A acetate, carotenoids such as α, β, γ-carotene, β-cryptoxanthene and exenone, and provitamin A such as xanthophylls. The vitamin D includes vitamins D such as vitamins D₂ to D₇.

Examples of other fat-soluble vitamin substances include esters such as vitamin E nicotinate and vitamins K such as vitamins K₁ to K₃.

Examples of oil-solubilized derivatives such as those of ascorbic acid and erythorbic acid include vitamin C fatty acid esters such as stearic acid L-ascorbic ester, tetraisopalmitic acid L-ascorbic ester, palmitic acid L-ascorbic ester, palmitic acid erythorbic ester, tetraisopalmitic acid erythorbic ester and dioleic acid ascorbic ester, and vitamin B₆ fatty acid esters such as pyridoxine dipalmitate, pyridoxine tripalmitate, pyridoxine dilaurate and pyridoxine dioctanoate. Among them, oil-solubilized derivatives of ascorbic acid and erythorbic acid can be used as radical scavengers.

Examples of saturated fatty acids include monovalent unsaturated fatty acids (ω-9, oleic acid etc.) and polyvalent unsaturated fatty acids (ω-3, ω-6), among which DHA, EPA, and α-linolenic acid (linseed oil) are preferable.

Among polyvalent fatty acids in a preferable aspect of the saturated fatty acids, ω-3 kind of fats and oils include linolenic acid, eicopentanoic acid (EPA) and docosahexaenoic acid (DHA), as well as fish oil containing them.

Among them, DHA is an abbreviation of docosahexaenoic acid which refers collectively to carboxylic acids (22:6) each having 22 carbon chains containing six double bonds, and usually has a cis-form double bond at the 4-, 7-, 10-, 13-, 16- and 19-positions important for the living body.

Examples of the oils and fats other than ω-3 kind of oils and fats include oils and fats (fatty oils) that are liquid at ordinary temperature, and solid oils and greases (fats) that are solid at ordinary temperature.

Examples that may be given of liquid oils and fats include olive oil, camellia oil, macadamia nut oil, castor oil, avocado oil, evening primrose oil, turtle oil, corn oil, mink oil, rapeseed oil, egg yolk oil, sesame oil, persic oil, wheat germ oil, sasanqua oil, linseed oil, sunflower oil, cotton seed oil, perilla oil, soybean oil, peanut oil, tea seed oil, kaya oil, rice bran oil, china wood oil, tung oil, hohoba oil, germ oil, triglycerin, glycerin trioctanoate, glycerin triisopalmitate, salad oil, sunflower oil (safflower oil), palm oil, coconut oil, peanut oil, almond oil, hazelnut oil, walnut oil, grape seed oil, squalene and squalane.

Examples that may be given of the solid oils and fats include beef tallow, hydrogenated beef tallow, hoof oil, beef bone oil, mink oil, egg yolk oil, lard, horse fat, mutton tallow, hydrogenated oil, cacao oil, coconut oil, hydrogenated coconut oil, palm oil, palm hydrogenated oil, Japan tallow, Japan tallow kernel oil and hydrogenated castor oil.

Of the above, coconut oil that is a medium-chain triglyceride is preferably used from the standpoints of particle size and stability of the emulsion composition.

The oil-soluble component is included preferably in an amount of 0.1 to 10% by mass, more preferably 0.5 to 5% by mass, still more preferably 1.0 to 4.0% by mass, with respect to the emulsion composition that is a base material of the powdered composition. This content in the emulsion composition is the content of the oil-soluble component in the whole of the emulsion composition containing the water phase. The concentration of the oil-soluble component in water that is the solvent of the emulsion composition is around 17.7% by mass, and therefore, the content of the oil-soluble component in the powdered composition is preferably 0.018 to 1.77% by mass.

When the content of the oil-soluble component is in the range defined above, the effect of the functional oil-soluble component can be sufficiently obtained, and the oil-soluble component can be effectively prevented from exuding onto the surface of the powder with time during storage, thus preferably achieving improvement in handleability.

Other oil components that can be used in the invention include components usually used as a UV absorber, an antioxidant, an anti-inflammatory agent, a humectant, a hair-protecting agent, a dispersant, a solvent, a skin-whitening agent, an anti-wrinkle agent, a cellular stimulant, an emollient agent, a keratolytic agent, an antistatic agent, vitamins, a metabolic syndrome-ameliorating agent, an antihypertensive agent, and an analgesic agent. Examples thereof include hydrocarbons such as liquid paraffin, paraffin, vaseline, ceresin and microcrystalline wax, waxes such as carnauba wax, candelilla wax, jojoba wax, beeswax and lanolin, esters such as isopropyl myristate, 2-octyldodecyl myristate, cetyl 2-ethylhexanoate and diisostearyl malate, fatty acids such as palmitic acid, stearic acid, isostearic acid, linolic acid and arachidonic acid, higher alcohols such as cetyl alcohol, stearyl alcohol, isostearyl alcohol and 2-octyl dodecanol, silicone oils such as methyl polysiloxane and methyl phenyl polysiloxane, and other polymers, oil-soluble pigments and oil-soluble proteins. Their mixtures, that is, various plant-derived oils and animal-derived oils are also included as the other oil components.

As the oil-soluble component in the invention, a compound selected from the group consisting of tocopherol, tocotrienol and derivatives thereof (hereinafter referred to sometimes as tocopherols) that are oil-soluble components included in fat-soluble vitamins is preferably included together with another functional oil-soluble component in the functional oil-soluble component in order to improve physical properties in the emulsion composition.

When the tocopherols are simultaneously used in the functional oil-soluble component, the tocopherols can be used preferably in the range of 5% by mass to 35% by mass, more preferably 7% by mass to 20% by mass, with respect to the total amount of the functional oil-soluble component.

For further improving dispersibility in water, two or more of the oil components described above are preferably simultaneously used, and the oil components that can be simultaneously used for this purpose are preferably DHA, squwalene and squwalane, among which squwalene is particularly preferable. Particularly, the oil component such as coenzyme Q10 that is solid at ordinary temperature is used preferably in combination with DHA, squwalene or squwalane.

In consideration of use in foods and cosmetics, the functional oil component is preferably a fat-soluble carotenoid, more preferably an astaxanthin.

Such a functional oil component is liable to the influence of oxidation in air, and from such a viewpoint, a radical scavenger is preferably used in combination with the oil component.

The radical trapping agent is an additive that suppresses generation of radicals, and further has a role of rapidly trapping radicals, thereby stopping a chain reaction from taking place (Source: Oil Chemistry Handbook, 4th edition, Japan Oil Chemists' Association, 2001).

Known methods of directly confirming the function as a radical trapping agent include a method in which the radical trapping agent is mixed with a reagent, and the state of trapping the radial is measured with a spectrophotomer or by ERS (electron spin resonance). Those methods use DPPH (1,1-diphenyl-2-picrylhydrazyl) or a garbinoxyl radial as the reagent.

In the invention, a compound that gives a time required to increase the peroxide value (POV) of an oil or fat to 60 meq/kg, utilizing an auto-oxidation reaction of oil and fat under the following experimental conditions, that is 2 times by weight or more that without the agent is defined as a “radial trapping agent”. The peroxide value (POV) of oil or fat is measured with the conventional method.

### <Conditions for Defining a Radical Trapping Agent>

Oil or fat: Olive oil

Amount of specimen added: 0.1% by mass with respect to mass of oil and fat

Test method: Sample was heated to 190° C., POV was measured with the passage of time by a conventional method, and time required to reach a POV of 60 meq/kg was calculated.

The radical trapping agent in the invention is preferably a trapping agent having a time required to reach POV of 60 meq/kg that is 5 times by weight or more that without the agent from the standpoint of stability to oxidation of an emulsion.

Compounds that can be used as the radical trapping agent of the invention may be any compound as long as it functions as a radical trapping agent in various antioxidants described in “Theory and Fact of Antioxidant” (Kajimoto, San Shobo, 1984) and “Antioxidant Handbook” (Saruwatari, Nishino and Tabata, Taiseisha, 1976), and specific examples thereof include compounds having phenolic OH, amine compounds such as phenylenediamine, and oil-solubilized derivatives of ascorbic acid and erythorbic acid.

Preferable examples of the radical scavenger (antioxidant) are illustrated below, but the invention is not limited thereto.

Preferably, the emulsion composition and highly concentrated emulsion of the invention contain at least two compounds selected from the group consisting of (I) a compound group of ascorbic acid, erythorbic acid, and salts thereof and (II) a compound group of polyphenols.

The content of the radical scavenger in the emulsion composition or highly concentrated emulsion of the invention is generally 0.001 to 5.0% by mass, preferably 0.01 to 3.0% by mass, more preferably 0.1 to 2.0% by mass.

Hereinafter, specific examples of the compounds in the compound groups (I) and (II) are illustrated, but are not intended to limit the compounds that can be used in the invention.

(I) Ascorbic acid, erythorbic acid, and salts thereof.

Ascorbic acid, erythorbic acid, and salts thereof include L-ascorbic acid, sodium L-ascorbate, potassium L-ascorbate, calcium L-ascorbate, L-ascorbate phosphate, magnesium L-ascorbate phosphate, L-ascorbate sulfate, disodium L-ascorbate sulfate, L-ascorbate stearate, L-ascorbate 2-glucoside, L-ascorbate palmitate, and tetraisopalmitate L-ascorbate. Particularly preferable among those mentioned above are L-ascorbic acid, sodium L-ascorbate, L-ascorbate stearate, L-ascorbate 2-glucoside, L-ascorbate palmitate, magnesium L-ascorbate phosphate, disodium L-ascorbate sulfate, and tetraisopalmitate L-ascorbate.

Erythorbic acid, erythorbic acid derivatives, and salts thereof include erythorbic acid, sodium erythorbate, potassium erythorbate, calcium erythorbate, erythorbate phosphate, erythorbate sulfate, erythorbate palmitate, and tetraisopalmitate erythorbate. Among them, erythorbic acid and sodium erythorbate are particularly preferable.

The radical scavenger belonging to the compound group (I) used in the invention may be a suitable one generally commercially available. Examples thereof include L-ascorbic acid (Takeda Pharmaceutical Company Limited, Fuso Kagaku, BASF Japan, Daiichi Pharmaceutical Co., Ltd., etc.), sodium L-ascorbate (Takeda Pharmaceutical Company Limited, Fuso Kagaku, BASF Japan, Daiichi Pharmaceutical Co., Ltd., etc.), ascorbate 2-glucoside (trade name: AA-2G, manufactured by Hayashibara Biochemical Labs., Inc.), magnesium L-ascorbate (Ascorbic Acid PM “SDK” (trade name, Showa Denko K.K.), NIKKOL VC-PMG (trade name, Nikko Chemicals Co., Ltd.), Seamate (trade name, Takeda Pharmaceutical Company Limited), and palmitate ascorbate (DSM Nutrition Japan, Kongo Yakuhin Co., Ltd., Merck, etc.).

(II) Compound group of polyphenols

The compound group of polyphenols includes flavonoids (catechin, anthocyanin, flavone, isoflavone, flavane, flavanone, rutin), phenolic acids (chlorogenic acid, ellagic acid, gallic acid, propyl gallate), lignans, curcumins and coumarins. These compounds are included in extracts derived from the following natural products, and thus can be utilized in the form of extracts.

Examples include a licorice extract, a cucumber extract, a Millettia reticulata stem extract, a Gentiana (gentian) extract, a Geranium thunbergii extract, cholesterols and derivatives thereof, a hawthorn extract, a peony root extract, a ginkgo extract, a Baikal skullcup (Scutellaria baicalensis) extract, a carrot extract, a rugosa rose extract, a KAWARAKETSUMEI extract, a Tormentilla extract, a parsley extract, a tree peony extract, a chaenomeles speciosa (Japanese quince) extract, a Melissa extract, a YASHA extract, a strawberry geranium extract, a rosemary extract, a lettuce extract, tea extracts (oolong, black tea, green tea etc.), microbial fermentative metabolism products, a Rakanka extract etc. (another name, herbal medicine name etc. are shown in round brackets). Preferable among these polyphenols are catechin, a rosemary extract, glucosyl rutin, ellagic acid, and gallic acid.

The radical scavenger belonging to the compound group (II) used in the invention may be a generally commercially available suitable one. Examples thereof include ellagic acid (Wako Pure Chemical Industries, Ltd.), rosemary extracts (trade names: RM-21A & RM-21E, manufactured by Mitsubishi Kagaku Foods etc.), catechin (trade names: Sankatol W-5 & No. 1, manufactured by Taiyo Kagaku Co., Ltd., etc.), sodium gallate (trade name: Sankatol, manufactured by Taiyo Kagaku Co., Ltd., etc.), and rutin/glycosyl rutin/enzymatically decomposed rutin (trade names: Rutin K-2 & P-10, manufactured by Kiriya Chemical Co., Ltd.; and trade name: aG rutin, manufactured by Hayashibara Biochemical Labs., Inc.).

The content of the functional oil component (a) in the powdered composition of the invention is preferably 0.1 to 10% by mass, more preferably 0.5 to 5% by mass, still more preferably 0.2 to 2% by mass.

When the content of the oil component is in the range defined above, the effect of the functional oil component can be sufficiently obtained, and the oil component can be effectively prevented from exuding onto the surface of the powder with time during storage, thus preferably achieving improvement in handleability.

When another oil component is used in combination with the fat-soluble functional material, the functional oil component may be used preferably in an amount of 10% by mass to 99% by mass, more preferably 50% by mass to 99% by mass, with respect to the whole of the oil component.

<Other Components>

Depending on the intended purpose, various components may be used in combination with the components described above in the powdered composition of the invention as long as the effect of the invention is not impaired.

<Process for Producing the Water-in-Oil Emulsion Composition>

In the invention, the process for producing the emulsion composition is not particularly limited. A preferable example of such process is a process for producing an emulsion composition, comprising the steps consisting of I) dissolving an emulsifier in an aqueous medium (water or a mixture of water and a polyhydric alcohol) to prepare a water phase, II) separately mixing and dissolving fat-soluble components (fat-soluble carotenoids or the like) and phospholipids to give an oil phase, and III) mixing the water phase with the oil phase under stirring and emulsifying and dispersing the mixture to give an emulsion composition.

In the production process, the components included respectively in the oil and water phases are the same as the constituent components in the emulsion composition of the invention, and preferable examples thereof and preferable amounts thereof are also the same as described therein and a preferable combination thereof is more preferable.

The ratio (mass) of the oil phase to the water phase in the emulsification dispersion is not particularly limited, but the oil phase:water phase ratio (% by mass) is preferably from 0.1:99.9 to 50:50, more preferably from 0.5:99.5 to 30/70, and further preferably from 1:99 to 20:80.

An oil phase:water phase ratio of 0.1:99.9 or more is preferred, since the effective components are not too low, there is the tendency that practical problems with the emulsion composition do not readily occur. An oil phase/water phase ratio of 50:50 or less is preferred, since the concentration of the surfactant is not too low, and there is the tendency that emulsion stability of the emulsion composition does not deteriorate.

The emulsification dispersion may be sufficient by carrying out the emulsification operation in one step, but it is preferable to carry out emulsion operation in two steps or more, from the point of obtaining uniform and fine emulsified particles.

Specifically, it is particularly preferable that two kinds or more of emulsification device are used in combination, by the method of emulsifying with a high pressure homogenizer or the like, in addition to the emulsification operation of one step of emulsifying using a general emulsification apparatus (for example, stirrer, impeller stirring, homomixer, continuous-flow shearing apparatus or the like) utilizing shear action. When a high pressure homogenizer is used, the emulsion may be formed with liquid droplets of more uniform fine particles. Furthermore, emulsification dispersion may be conducted repeatedly for the purpose of forming liquid droplets having more uniform particle sizes.

In the invention, the temperature condition in emulsification and dispersion is not particularly limited, but from the viewpoint of the stability of the fat-soluble substance, the temperature is preferably 10 to 100° C., and can be selected in a suitable range depending on the melting point of the fat-soluble substance to be handled.

The high pressure homogenizer includes a chamber type high pressure homogenizer having a chamber with a fixed flow path for a treatment solution and a homogenous-valve type having a homogenous valve. Among them, the homogenous-valve type high pressure homogenizer can easily regulate the width of a flow path for a treatment solution and can arbitrarily establish the pressure and flow rate during operation to make its operation range broad and is thus preferable for the process for producing the emulsion composition in the invention.

The chamber type high pressure homogenizer, though being poor in the degree of freedom in operation, can easily create a mechanism of increasing pressure and is thus preferably usable where ultrahigh pressure is required.

The chamber type high pressure homogenizer includes a Microfluidizer (manufactured by Microfluidex International Corporation), Namomizer (manufactured by Yoshida Kikai Co., Ltd.) and Altimizer (manufactured by Sugino Machine Co., Ltd.).

The homogeneous-valve type high pressure homogenizer includes a Gaulin homogenizer (A. P. V Gaulin Inc.), a Ranie type homogenizer (manufactured by Ranie), a high pressure homogenizer (manufactured by Niro Soavi), a homogenizer (manufactured by Sanwa Machine Co., Ltd.), a high pressure homogenizer (Izumi Food Machinery Co., Ltd.) and an ultrahigh pressure homogenizer (manufactured by ICA A. G.).

In the invention, the pressure in the high-pressure homogenizer is preferably 50 MPa or more, more preferably 50 to 250 MPa, still more preferably 100 to 250 MPa.

From the viewpoint of maintaining the size of dispersed particles, the emulsified and dispersed composition in the form of an emulsion is preferably cooled with a cooling device within 30 seconds, preferably 3 seconds, after the composition was passed through the chamber.

In another dominant method for obtaining the finely emulsified product, an ultrasonic homogenizer is used. A specific method known in the art involves emulsification with a usual emulsification apparatus utilizing shear action as described above, followed by irradiation with ultrasound at a frequency of 15 to 40 kHz. However, an ultrasound-generating apparatus capable of irradiation in a sufficient scale is still not commercially marketed, and where a small apparatus is used, there is a limit to the volume of a liquid medium treated therewith. Accordingly, the process for producing the emulsified product by using such an ultrasound-generating apparatus is extremely excellent in respect of the performance of the resulting emulsified product, but the amount of the liquid medium treatable therewith is reduced, thus making industrial mass production difficult.

The recent progress of high-power ultrasound irradiation apparatuses has rendered mass production feasible to a certain degree. Examples of high-power ultrasonic homogenizers include ultrasonic homogenizers US-1200T, RUS-1200T and MUS-1200T (manufactured Nippon Seiki Co., Ltd.) and ultrasonic processors UIP2000, UIP-4000, UIP-8000 and UIP-1600 (manufactured by Hircher A. G. [phonetic]). These high-power ultrasonic irradiation apparatuses are used at a frequency of 25 kHz or less, preferably at a frequency of 15 to 20 kHz and with an energy density of 100 W/cm² or more, preferably 120 W/cm², on a dispersing portion, to enable fine emulsification.

The ultrasonic irradiation may be in a batch system, which is preferably used in combination with a means of stirring the whole of the dispersion liquid. The stirring means used in this case is an agitator, a magnetic stirrer and a disper for stirring. More preferably, flow-type ultrasound irradiation can be conducted. The flow-type apparatus is provided with a dispersion liquid supply tank and a supply pump by which a dispersion liquid is sent at a constant flow rate into a chamber provided with an ultrasonic irradiation unit. The liquid may be fed to the chamber in any direction to attain its effect, but a method of feeding the fluid along the direction in which the fluid perpendicularly encounters a face irradiated with ultrasound is particularly preferable.

The time of ultrasound irradiation is not particularly limited, but is preferably 2 to 200 minutes/kg during which the inside of the container is substantially irradiated with ultrasound. Too short time leads to insufficient emulsification, while too long time may result in re-aggregation. The optimum time varies depending on the intended emulsified product, but a generally preferable time is between 10 minutes to 100 minutes.

The increase in the temperature of the emulsified liquid caused by irradiation with high-density energy may induce deterioration in constituent components in the emulsified product and re-aggregation of particles, and thus a cooling means is preferably used in combination with the irradiation apparatus. In the case of batch irradiation, the irradiation container may be externally cooled, or a cooling unit may be arranged in the container. In the case of flow-type irradiation, it is preferable that the ultrasound irradiation chamber is externally cooled, or alternatively a cooling means such as a heat exchanger is arranged anywhere on flow circulation.

More preferable dispersion can be achieved when the ultrasound homogenizer is used in combination with the ultrahigh pressure homogenizer. That is, the usual emulsification device utilizing shear action is used in emulsification, and then the ultrahigh pressure homogenizer is used in dispersion, thereby increasing the efficiency of dispersion with the ultrahigh pressure homogenizer to reduce the number of passes and simultaneously reducing coarse particles thereby enabling acquisition of a high-quality emulsified product. Alternatively, the ultrahigh pressure homogenizer is used in emulsification followed by ultrasound irradiation, thereby enabling reduction in coarse particles. Alternatively, these steps may be repeatedly conducted in an arbitrary order, for example by conducting ultrahigh pressure dispersion and ultrasound irradiation alternately.

The emulsion composition obtained by such process is an O/W emulsion in which fat-soluble substance-containing emulsified particles are dispersed in an aqueous medium.

For determining the characteristics of the powdered composition of the invention, it is particularly important in the invention to obtain the emulsion composition in which fine emulsion particles are uniformly dispersed.

### <Particle Size and Evaluation of the Emulsion Composition>

The particle size of the emulsion composition of the invention is preferably 20 nm or less from the viewpoint of particle stability and transparency, more preferably 130 nm or less, most preferably 90 nm or less, from the viewpoint of transparency.

The particle size of the emulsion composition of the invention can be measured with a commercially available particle size distribution measuring device. Optical microscopy, confocal laser microscopy, electron microscopy, atomic force microscopy, static light scattering method, laser diffraction method, dynamic light scattering method, centrifugal precipitation method, electric pulse measurement method, chromatography method, ultrasonic damping method and the like are known as particle size distribution measurement methods of an emulsion, and devices corresponding to the respective principle are commercially available.

From particle size range in the invention and ease of measurement, a dynamic light scattering method is preferred in the emulsion particle size measurement of the invention. Commercially available measurement devices using dynamic light scattering include Nanotrac UPA (Nikkiso Co., Ltd.), dynamic light scattering particle size distribution measuring device LB-550 (Horiba, Ltd.) and fiber-optics particle size analyzer FPAR-1000 (Otsuka Electronics Co., Ltd.).

When the particle size of the emulsion composition in the invention is measured with, for example, a fiber-optics particle size analyzer FPAR-1000 (Otsuka Electronics Co., Ltd.), 10 mass % aqueous solution of the emulsion composition is prepared and measured for its particle size under standard measurement conditions of the analyzer. When the powdered composition is measured, 1 mass % aqueous solution of the powdered composition is prepared and measured for its particle size under the same conditions as in measuring the emulsion composition.

The particle size of the emulsion composition can regulated not only by the components in the emulsion composition, but also by factors such as stirring conditions (shear force, temperature, pressure) in the production process, the ratio of the oil phase to the water phase, and the like.

The particle size in the invention is expressed in D₅₀ as determined with the fiber-optics particle size analyzer FPAR-1000 (Otsuka Electronics Co., Ltd.).

The particle size used in the invention is a value determined at 25° C.

<Preparation of the Powdered Composition>

The emulsion preparation obtained as described above is then subjected to drying in a drying process.

The drying method usable in this process may be any method usually used for this purpose, and examples of such methods include spray drying, freeze drying, vacuum drying, tray drying, belt drying, and drum drying. Among them, spray drying and freeze drying are preferable from the viewpoint of handling of the powder. The powder dried by spray drying or the like may be collected with an apparatus based on the principle of cyclone.

In the invention, the emulsifier and the oil-soluble component are suitably selected, whereby the aggregation of powders attributable to the sticky surfaces of the powders in the drying process, and the adhesion of the powders to an internal wall of a drying device, are suppressed, thereby making the yield of the powders excellent in the drying process.

The yield in the drying process is determined as shown below, and in the invention, this yield can be 60% or more.

### (Yield Calculation Method)

Now, the calculation method is described by reference to an example wherein spray drying was used as a drying method and powders after drying were recovered by collection with a cyclone.

| | |
|---|---|
| Emulsion composition used in the drying process | A kg |
| Nonvolatile content in the emulsion | x % |
| Powders collected with the cyclone | B kg |
| Nonvolatile content in the powders | y % (after drying at |
| | 105° C. for 6 hours) |

Using the above numerical values, the yield is calculated according to the following equation:

Yield=[(B×y)/(A×x)]×100 (%)

When the emulsion composition prepared by suitably selecting the type of the emulsifier and the ratio of the emulsifier to the oil-soluble component as described above is used as the base material in the invention, the surfaces of powders can be prevented from becoming sticky even in the drying process, and thus the powdered composition of the invention obtained in this manner can be re-dissolved in an aqueous medium depending on the intended product to constitute an emulsion composition having storage stability excellent for particle diameter and being excellent in an ability to disperse a pigment and emulsion particles.

The average particle size of the emulsion composition obtained after re-dissolution can be 150 nm or less in 1 mass % aqueous solution of the composition, from the viewpoint of transparency and absorbability, and is preferably from 1 nm to less than 130 nm, from the viewpoint of excellent transparency, dispersion stability, and storage stability.

The powdered composition containing an oil-soluble component of the invention can be used to obtain an emulsion excellent not only in transparency and dispersion stability but also in an ability to stabilize the emulsification of the functional oil-soluble component, and can thus be preferably applied to food compositions, cosmetic compositions and pharmaceutical compositions.

The oil-soluble component-containing powdered composition of the invention can be stored as powder for a long period of time, and can be re-dissolved and used in particularly water-soluble products, for example drinks (in the case of foods), a face lotion, a toner, a milky lotion, a cream pack/mask, a pack, a hair lotion, fragrance cosmetics, liquid body cleansing preparations, UV care cosmetics, deodorant cosmetics and oral care cosmetics (in the case of cosmetics), thereby giving clear products and simultaneously preventing inconvenient phenomena such as precipitation, settling and neck ring [phonetic] of insolubles during long-term storage or under sever conditions such as in sterilization.

The content of water in the powered composition of the invention is preferably 0.5% to 3.0%, from the viewpoint of maintaining excellent re-dispersibility and re-solubility.

In the invention, the foods include drinks and frozen desserts, cosmetics include skin cosmetics (a face lotion, a toner, a milky lotion, a cream etc.), lipsticks, sunscreen cosmetics and makeup cosmetics, and the pharmaceutical preparations include nutritious drinks and revitalizers, but the invention is not limited thereto.

The food composition, cosmetic composition and pharmaceutical composition of the invention can be obtained in a usual manner for example by mixing the powdered composition of the invention with arbitrary components that can be added for achieving the desired object.

The powdered composition may be mixed with other components, in a powdered state or after re-dissolution in an aqueous medium, depending on a wide variety of intended product compositions.

[Functional Food]

The functional food of the invention contains the powdered composition containing an oil-soluble component of the invention.

Preferable forms of the functional food of the invention include, but are not limited to, nutritious drinks, revitalizers, palatable drinks and general foods such as frozen desserts, as well as supplements in the form of tablets, granules or capsules.

The functional food of the invention can be obtained in a usual manner for example by mixing the powdered composition containing an oil-soluble component of the invention with arbitrary components that can be added for achieving the desired object.

The powdered composition of the invention may be formed into foods by mixing it with other components, in a powdered state or after re-dissolution in an aqueous medium, depending on a wide variety of intended product compositions.

The amount of the powdered composition of the invention used in foods, cosmetics, pharmaceutical preparations etc. cannot be generalized because it varies depending on the type and object of the product. However, the powdered composition can be added and used in the range of 0.01 to 10% by mass, preferably 0.05 to 5% by mass, with respect to the intended product.

The powdered composition when added in an amount of 0.01% by mass or more can exhibit its intended effect and when added in an amount of 10% by mass or less can often exhibit its suitable effect efficiently.

<<Packaged Product>>

Hereinafter, a preferable packaging article for packaging the powdered composition of the invention and a packaging material used therein are described in detail.

When the powdered composition of the invention is stored for a long time or transported for preparing an emulsified product, the powdered composition is required to maintain the specified water content for maintaining emulsion dispersibility and also to maximally suppress the influence of oxygen and moisture in air and light, the packaging article of the invention is required to enclose the powdered composition in the presence of a deoxidant and a desiccant into a container using, as at least outermost layer, a packaging material having an oxygen transmission rate of 50 mL/m²/atm/day or less and a moisture transmission degree of 40 g/m²/day or less.

<Packaging Material>

The packaging material used in the invention is a material having an oxygen transmission rate of 50 mL/m²/atm/day or less and a moisture transmission degree of 40 g/m²/day or less. The oxygen transmission rate is more preferably 10 mL/m²/atm/day or less, and the moisture transmission degree is more preferably 5 mL/m²/atm/day or less.

The packaging material having an oxygen transmission rate of 50 mL/m²/atm/day or less can be suitably selected from a single-layer or multilayer resin film, a metal foil-laminated resin film and a metal-deposited film insofar as these films satisfy the condition defined above.

As long as the powdered composition enclosed in the packaging material can remain hermetically closed, the packaging material may be in any shape and may be for example a glass bottle or a bottle formed from a polymer material. A bag formed by sticking resin film materials to each other via a specific adhesive or by fusing them through pressure bonding under heating is preferable for packaging the powdered composition with no excessive space remaining therein, and a reclosable packaging bag is preferable from the viewpoint of allowing the powdered material to be kept in a hermetically closed state again after the bag is once opened.

Specifically, resin films capable of forming the packaging bag include, for example, polyvinylidene chloride, nylon, a saponified ethylene-vinyl acetate copolymer (which is commercially available for example under the trade name Eval from Kuraray Co., Ltd.), polyvinyl alcohol (which is commercially available for example under the trade name of Vinylon from Kuraray Co., Ltd.), and polyvinyl chloride. These resin films can achieve the above-defined oxygen transmission rate by regulating the molecule weight of the resin and the density and thickness of the film. Depending on the object, a laminate produced by laminating different kinds of resin films with each other may be used, or a laminate produced by laminating a colored resin film with a transparent resin film may be used.

When the packaging material is composed of a single-layer resin film or resin films in a laminated state, the total thickness of the film(s) is generally preferably in the range 20 μm to 1000 μm, more preferably 40 μm to 300 μm.

When used in a laminated state, different kinds of films may be laminated with each other, or a single-layer resin film may be coated with another resin material, or a coated resin film may be laminated on another resin film. Examples of such combinations of resin materials include biaxially oriented polypropylene (OPP)/polyethylene (PE), OPP/ethylene vinyl acetate (EVA), OPP/linear low-density polyethylene (LLDPE), OPP/casted polypropylene (CPP), an OPP/ethylene vinyl alcohol copolymer (EVOH)/PE, a polyvinylidene chloride-coated OPP film (KOH)/PE, KOP/EVA, KOP/LLDPE, KOP/CPP, polyethylene terephthalate (PET)/PE, PET/EVA, PET/LLDPE, PET/CPP, a PET film coated one side with polyvinylidene chloride (KPET)/PE, KPET/EVA, KPET/LLDPE, KPET/CPP, oriented nylon (ON)/PE, ON/EVA, ON/LLDPE, ON/CPP, an ON film coated on one side with polyvinylidene chloride (KON)/PE, KON/CPP, PET/VMPET/PE, PET/VMPET/EVA, PET/VMPET/LLDPE, and PET/AL/CPP.

From the viewpoint of keeping breathability low, a resin film laminated with a metal foil or a metal-deposited resin film is also preferably used, and examples thereof include PET/aluminum foil (AL)/PE, OPP/aluminum-deposited polyethylene terephthalate (VMPET)/CPP, and OPP/aluminum-deposited casted polypropylene (VMCPP).

More preferable among those mentioned above are those laminated films constituted to have an aluminum foil between resin films, such as PET/AL/PE and PET/AL/CPP and those constituted to have an aluminum-deposited film between resin films, such as OPP/VMPET/CPP, PET/VMPET/PE, PET/VMPET/EVA and PET/VMPET/LLDPE. These films can be preferably as the packaging material of the invention.

When the packaging material is not required to be transparent, or when a component easily deteriorated with light is incorporated into the powdered composition to be enclosed, a resin film laminated with a metal foil or a resin film having a metal-deposited membrane can also be preferably used. By the presence of the metal layer, these laminated films can achieve not only a light blocking effect but also excellent oxygen barrier properties and moisture barrier properties. Particularly when a colored active ingredient such as astaxanthin is included, the packaging material having such a metal layer is useful.

The metal-foil laminate is typically an aluminum foil-laminated film. When a metal-deposited film is used, the metal-deposited film is also preferably an aluminum-deposited film, from the viewpoint of durability and easy handleability. The resin films for the metal foil laminate or for metal deposition are preferably those using polyethylene or an ethylene-vinyl acetate copolymer as their substrate.

The thickness of the metal foil is preferably in the range of 1 μm to 30 μm. The thickness of the metal-deposited layer formed is preferably in the range of 0.1 μm to 2 μm.

Among them, the aluminum foil-laminated film is preferable from the viewpoint of the stability of a material enclosed therein.

The material having a moisture transmission degree of 40 g/m²/day or less includes polyvinylidene chloride, nylon, a saponified ethylene-vinyl acetate copolymer (trade name: Eval, manufactured by Kuraray Co., Ltd.), polyvinyl alcohol (trade name: Vinylon, manufactured by Kuraray Co., Ltd.) and polyvinyl chloride as described above, as well as polyethylene terephthalate, polybutylene terephthalate, and polyethylene naphthalate. The film laminated with a metal foil such as aluminum and the film deposited with a metal such as aluminum are also those satisfying the conditions defined in the invention.

The packaging article used in the invention encloses a deoxidant and a desiccant together with the powdered composition in a container formed from the packaging material.

The powdered composition, the deoxidant and the desiccant may be contained in different bags respectively and enclosed in the container, or two of them may be included in another bag, but the powdered composition should be packaged as powders without being mixed with the deoxidant and the desiccant.

Accordingly, the powdered composition may be enclosed directly in the container composed of the packaging material or may be contained in a bag composed of a packaging material having an oxygen transmission rate of more than 50 mL/m²/atm/day and a moisture transmission degree of more than 40 g/m²/day and then enclosed in the container.

<Deoxidant>

The deoxidant used in the invention is used mainly for inhibiting oxidative deterioration of the functional oil component included in the powdered composition.

The deoxidant usable in the invention includes, for example, commercially available Ageless (trade name, manufactured by Mitsubishi Gas Chemical Co., Inc.), Tamotsu (trade name, manufactured by OhE Chemicals Inc.), Wanderkeep (trade name, manufactured by Powder-tech Co., Ltd.), Secule (trade name, manufactured by Nisso Jyushi Co., Ltd.), Modulane (trade name, Nippon Kayaku Co., Ltd.) and Sansocut (trade name, manufactured by Nittetsu Fine Product Co., Ltd.).

When the powdered composition should keep a very low water content (for example 0.3 or less in terms of water activity), a deoxidant having a low water content, that is, a deoxidant of low water activity, is preferably selected, and specific examples of the deoxidant of low water activity include Ageless ZP-K and Ageless E-150 (manufactured by Mitsubishi Gas Chemical Co., Inc.), Tamotsu D (trade name, manufactured by OhE Chemicals Inc.) and Wanderkeep RP (trade name, manufactured by Powder-tech Co., Ltd.).

For preventing the deoxidant from being mixed with the powdered composition, it is preferable that the deoxidant is contained in a bag consisting of a breathable film having minute openings through which the deoxidant component or particles constituting the powdered composition cannot pass, and then enclosed in the container, or the deoxidant is enclosed in a packaging container having a multilayer structure divided with a breathable film, wherein the deoxidant is enclosed in a layer different from that of the powdered composition.

The breathable film includes nonwoven fabrics consisting of synthetic fibers such as polypropylene, a porous film having minute openings, rayon paper and Japanese paper.

The deoxidant is used preferably in such an amount (size) as to have oxygen absorption capacity suited to the inner volume of the packaging container, from the viewpoint of its effect.

<Desiccant>

The desiccant usable in the invention include, for example, aluminum oxide, calcium chloride, calcium oxide (lime), active calcium sulfate anhydride, magnesium oxide, magnesium perchlorate, magnesium sulfate anhydride, phosphorus pentaoxide, potassium carbonate, potassium hydroxide, silica gel, sodium hydroxide, sodium sulfate and zinc chloride. Among them, calcium chloride, calcium oxide (lime) and silica gel are particularly preferable from the viewpoint of safety making them preferably usable in foods etc.

For preventing the desiccant from being mixed with the powdered composition, it is preferable that like the deoxidant, the desiccant similar is contained in a breathable film and then enclosed in the container, or the desiccant is enclosed in a packaging container having a multilayer structure divided with a breathable film, wherein the desiccant is enclosed in a layer different from that of the powdered composition.

The breathable film may be the same as for the deoxidant. When silica gel of relative large particle size is used as the desiccant, a resin film further partially having breathing holes in the form of a mesh or a porous film may be used.

A necessary amount of for example silica gel as the desiccant can be calculated by a method described in JIS-Z-0301. A necessary amount of other desiccants can also be calculated from the inner volume of the container, the water content of the powdered composition, etc., and can be suitably determined depending on the object.

A preferable amount of the desiccant varies depending on its type, but generally the desiccant is used preferably in the range of 3 to 30 parts by mass, more preferably in the range of 3 to 15 parts by mass, with respect to 100 parts by mass of the powdered composition.

Preferably the desiccant is enclosed in the vicinity of the deoxidant in order to regulate the amount of water not only in the powdered composition but also in the coexistent deoxidant.

Both the desiccant and the deoxidant may be mixed with each other and included in one bag composed of a breathable film, but because the desiccant is often recyclable, the two are included preferably in separate bags.

When the deoxidant and/or the desiccant is included in a bag, each of them may be included and enclosed in a plurality of bags instead of one bag in each packaging article, for the purpose of increasing its contact area with the powdered composition.

The packaging article of the invention in the mode described above can be preferably used for storage or transportation of the powdered composition, and when the powdered composition after storage or transportation is added to an aqueous medium, the composition can be rapidly re-dispersed to give an emulsion composition capable of forming stable and finely emulsified particles, for example emulsified particles having an average particle size of from 1 nm to less than 130 nm in 1% aqueous solution.

The disclosure of Japanese Patent Application No. 2007-213712 filed on Aug. 20, 2007, and Japanese Patent Application No. 2007-230582 filed on Sep. 5, 2007, is incorporated herein by reference in its entirety.

### EXAMPLES

Hereunder is a specific description of exemplary embodiments of the present invention with reference to Examples. However, the present invention is not limited to these Examples. In the following description, “parts” and “%” are based on mass unless otherwise noted.

### Example 1

### 1. Preparation of an Emulsion

The following components were dissolved for 1 hour by heating at 70° C. to prepare a water phase composition

| | |
|---|---|
| Water | 246.9 g |
| Lecithin (Lecion P) | 1.3 g |
| Sugar ester (L-1695, mp: 47° C.) | 5.9 g |
| Polyglycerin ester (Decaglyn 1-L) | 2.0 g |
| Inulin | 34.7 g |

Separately, the following components were dissolved for 1 hour by heating at 70° C. to give an oil phase composition.

| | |
|---|---|
| Haematococcus alga extract (astaxanthin content of | 7.8 g |
| 20.3% by mass) | |
| Mixed tocopherol | 1.3 g |

The water phase was kept at 70° C. and stirred with a homogenizer (10000 rpm), and the oil phase was added to it to give an emulsified product. The preliminarily emulsified product thus obtained was sonicated (5 min) and then emulsified at 60° C. at a pressure of 200 MPa with Altimizer HJP-25005 (manufactured by Sugino Machine Co., Ltd.) to give an emulsion composition.

The particle size of emulsified particles in the resulting emulsion composition, as determined by the following method, was 50 nm, and the presence of finely emulsified particles was confirmed.

The particle size of the emulsified particles in the water-diluted emulsified product was measured with a fiber-optics particle size analyzer FPER-1000 (Otsuka Electronics Co., Ltd.).

Thereafter, the emulsion composition was dried by spray drying and collected with a cyclone to prepare a powdered composition (powder sample) 1 containing 3 mass % astaxanthin in Example 1.

### <Yield>

The yield of the powdered composition 1 was 91% as determined on the basis of the amounts of the emulsion composition and the powders by using the formula in the previously described yield calculation method, and it was confirmed that the powdered composition 1 can be obtained in high yield.

<Evaluation of the Powdered Composition>

### (Particle Size of Emulsified Particles in a Re-Dispersed Emulsion Composition)

1 g of the powdered composition 1 was added to 99 g water to prepare an emulsion composition, and the average particle size of emulsified particles in the emulsion composition was measured in the same manner as above under the measurement condition of 25° C. The result indicated that the particle size of the emulsified particles is 121 nm, and it was revealed that finely emulsified particles can be obtained even in the emulsion composition obtained by re-dispersion.

<Adhesive property>

The spray dryer with which the emulsion composition obtained above had been dried was visually examined for its inner wall after drying of the powders had bee finished. As a result, a viscous adhering matter or a deposited matter was not observed except for a very small amount of an adhering matter adhering electrostatically to the inner wall.

### <Processability>

The resulting powdered composition was charged into capsules by means of a hard capsule charging machine (GKF-400, manufactured by BOSCH). During this operation, the fluidity of the powdered composition, the fluctuation in the weight of the composition to be charged, and the undesired adhesion of powders to the charging machine or to an outer wall of a capsule were comprehensively evaluated. When there was no practical problem, “A” was given, and when there was a practical problem in any of fluidity, uniform weighing and adhesion of powders to the machine due to mutual adhesion of powders, “C” was given.

These evaluation results are shown in Table 2.

### Example 2

The following components were dissolved for 1 hour by heating at 70° C. to prepare a water phase composition 2.

| | |
|---|---|
| Water | 246.9 g |
| Lecithin (Lecion P) | 0.8 g |
| Sugar ester (monoester P) | 5.0 g |
| Inulin | 35.7 g |

Separately, the following components were dissolved for 1 hour by heating at 70° C. to give an oil phase composition 2.

| | |
|---|---|
| Haematococcus alga extract (astaxanthin content of | 9.2 g |
| 20.3% by mass) | |
| Mixed tocopherol | 2.4 g |

An emulsion composition was obtained in the same manner as in Example 1 except that the water phase composition 2 and the oil phase composition 2 were used, and then the resulting composition was dried in the same manner as in Example 1, whereby a powdered composition containing 3.5 mass % astaxanthin in Example 2 was obtained.

The powdered composition was evaluated in the same manner as in Example 1. The results are shown in Table 2 below.

### Example 3

The following components were dissolved for 1 hour by heating at 70° C. to prepare a water phase composition 3.

| | |
|---|---|
| Water | 246.9 g |
| Lecithin (Lecion P) | 1.8 g |
| Sugar ester (S-1670) | 10.0 g |
| Polyglycerin ester (DS-3) | 1.1 g |
| Inulin | 31.5 g |

Separately, the following components were dissolved for 1 hour by heating at 70° C. to give an oil phase composition 3.

| | |
|---|---|
| Haematococcus alga extract (astaxanthin content of 20.3% by | 7.8 g |
| mass) | |
| Mixed tocopherol | 0.8 g |

An emulsion composition was obtained in the same manner as in Example 1 except that the water phase composition 2 [sic] and the oil phase composition 2 [sic] were used, and then the resulting composition was dried in the same manner as in Example 1, whereby a powdered composition containing 3.0 mass % astaxanthin in Example 3 was obtained.

The powdered composition was evaluated in the same manner as in Example 1. The results are shown in Table 2 below.

### Example 4

### 1. Preparation of an Emulsion

The following components were dissolved for 1 hour by heating at 70° C. to prepare a water phase composition 4.

| | |
|---|---|
| Water | 246.9 g |
| Lecithin (Lecion P) | 1.6 g |
| Sugar ester (L-1695) | 8.4 g |
| Polyglycerin ester (Decaglyn 1-L) | 1.5 g |
| Inulin | 30.1 g |

Separately, the following components were dissolved for 1 hour by heating at 70° C. to give an oil phase composition 4.

| | |
|---|---|
| Haematococcus alga extract (astaxanthin content of 20.3% by | 10.5 g |
| mass) | |
| Mixed tocopherol | 1.0 g |

An emulsion composition was obtained in the same manner as in Example 1 except that the water phase composition 4 and the oil phase composition 4 were used, and then the resulting composition was dried in the same manner as in Example 1, whereby a powdered composition containing 4.0 mass % astaxanthin in Example 4 was obtained.

The powdered composition was evaluated in the same manner as in Example 1. The results are shown in Table 2 below.

### Example 5

The following components were dissolved for 1 hour by heating at 70° C. to prepare a water phase composition 5.

| | |
|---|---|
| Water | 206.4 g |
| Lecithin (Lecion P) | 3.8 g |
| Sugar ester (L-1695) | 19.9 g |
| Inulin | 42.0 g |

Separately, the following components were dissolved for 1 hour by heating at 70° C. to give an oil phase composition 5.

| | |
|---|---|
| DHA-70 (DHA content of 70% by mass, manufactured by | 26.7 g |
| Maruha Corporation) | |
| Mixed tocopherol | 1.2 g |

An emulsion composition was obtained in the same manner as in Example 1 except that the water phase composition 5 and the oil phase composition 5 were used, and then the resulting composition was dried in the same manner as in Example 1, whereby a powdered composition containing 20 mass % DHA as an oil-soluble component in Example 5 was obtained.

The powdered composition was evaluated in the same manner as in Example 1. The results are shown in Table 2 below.

### Example 6

The following components were dissolved for 1 hour by heating at 70° C. to prepare a water phase composition 6.

| | |
|---|---|
| Water | 206.4 g |
| Lecithin (Lecion P) | 4.3 g |
| Sugar ester (L-1695) | 11.25 g |
| Sugar ester (monoester P) | 11.25 g |
| Inulin | 40.1 g |

Separately, the following component was dissolved for 1 hour by heating at 70° C. to give an oil phase composition 6.

| | |
|---|---|
| DHA-70 (DHA content of 70% by mass, manufactured by | 26.7 g |
| Maruha Corporation) | |

An emulsion composition was obtained in the same manner as in Example 1 except that the water phase composition 6 and the oil phase composition 6 were used, and then the resulting composition was dried in the same manner as in Example 1, whereby a powdered composition containing 20 mass % DHA as an oil-soluble component in Example 6 was obtained.

The powdered composition was evaluated in the same manner as in Example 1. The results are shown in Table 2 below.

### Comparative Example 1

### 1. Preparation of an Emulsion

The following components were dissolved for 1 hour by heating at 70° C. to prepare a water phase composition C1.

| | |
|---|---|
| Water | 246.9 g |
| Lecithin (Lecion P) | 1.4 g |
| Decaglyn 1-L | 1.5 g |
| Inulin | 33.2 g |

Separately, the following components were dissolved for 1 hour by heating at 70° C. to give an oil phase composition C1.

| | |
|---|---|
| Haematococcus alga extract (astaxanthin content of 20.3% by | 7.8 g |
| mass) | |
| Mixed tocopherol | 2.1 g |

An emulsion composition was obtained in the same manner as in Example 1 except that the water phase composition C1 and the oil phase composition C1 were used, and then the resulting composition was dried in the same manner as in Example 1, whereby a powdered composition containing 3.0 mass % astaxanthin in Comparative Example 1 was obtained.

The powdered composition was evaluated in the same manner as in Example 1. The results are shown in Table 2 below.

### Comparative Example 2

The following components were dissolved for 1 hour by heating at 70° C. to prepare a water phase composition C2.

| | |
|---|---|
| Water | 200.0 g |
| Lecithin (Lecion P) | 3.9 g |
| Decaglyn 1-L | 20.4 g |
| Inulin | 38.0 g |

Separately, the following component was dissolved for 1 hour by heating at 70° C. to give an oil phase composition C2.

| | |
|---|---|
| DHA-70 (DHA content of 70% by mass, manufactured by | 25.9 g |
| Maruha Corporation) | |
| Mixed tocopherol | 2.6 g |

An emulsion composition was obtained in the same manner as in Example 1 except that the water phase composition C2 and the oil phase composition C2 were used, and then the resulting composition was dried in the same manner as in Example 1, whereby a powdered composition containing 20 mass % DHA in Comparative Example 2 was obtained.

The powdered composition was evaluated in the same manner as in Example 1. The results are shown in Table 2 below.

### Comparative Example 3

The following components were dissolved for 1 hour by heating at 70° C. to prepare a water phase composition C3.

| | |
|---|---|
| Water | 246.9 g |
| Lecithin (Lecion P) | 1.3 g |
| Sugar ester (O-1570: mp 43° C.) | 5.9 g |
| Decaglyn 1-L | 2.0 g |
| Inulin | 34.7 g |

Separately, the following components were dissolved for 1 hour by heating at 70° C. to give an oil phase composition C3.

| | |
|---|---|
| Haematococcus alga extract (astaxanthin content of 20.3% by | 7.8 g |
| mass) | |
| Mixed tocopherol | 1.3 g |

An emulsion composition was obtained in the same manner as in Example 1 except that the water phase composition C3 and the oil phase composition C3 were used, and then the resulting composition was dried in the same manner as in Example 1, whereby a powdered composition containing 3.0 mass % astaxanthin in Comparative Example 3 was obtained.

The powdered composition was evaluated in the same manner as in Example 1. The results are shown in Table 2 below.

The main components used in Examples 1 to 6 and Comparative Examples 1 to 3 are summarized in Table 1 below.

TABLE 1

| | | Emulsifier | | | | Sucrose | |
|---|---|---|---|---|---|---|---|
| | | (sucrose | Melting | Poly | Melting | fatty acid | Emulsifier/ |
| | Oil-soluble | fatty | point | glycerin | point | ester/ | oil-soluble |
| | component | acid ester) | (° C.) | ester | (° C.) | emulsifier | component |
| Example 1 | astaxanthin | L-1695 | 47 | Decaglyn | viscous | 65% | 1.00 |
| | oil | | | 1-L | liquid | | |
| Example 2 | astaxanthin | monoester-P | 45 | — | — | 86% | 0.50 |
| | oil | | | | | | |
| Example 3 | astaxanthin | S-1670 | 56 | DS-3 | 58 | 77% | 1.50 |
| | oil | | | | | | |
| Example 4 | astaxanthin | L-1695 | 47 | Decaglyn | viscous | 73% | 1.00 |
| | oil | | | 1-L | liquid | | |
| Example 5 | DHA | L-1695 | 47 | — | — | 84% | 0.85 |
| Example 6 | DHA | L-1695 | 47 | — | | 84% | 1.00 |
| | | monoester-P | 45 | — | | | |
| Comparative | astaxanthin | — | — | Decaglyn | viscous | 0.00 | 1.00 |
| Example1 | oil | | | 1-L | liquid | | |
| Comparative | DHA | — | — | Decaglyn | viscous | 0.00 | 0.85 |
| Example 2 | | | | 1-L | liquid | | |
| Comparative | astaxanthin | O-1570 | 43 | Decaglyn | viscous | 65% | 1.00 |
| Example 3 | oil | | | 1-L | liquid | | |

The sucrose fatty acid esters shown in Table 1, that is, L-1695, monoester P, S-1670, M-1695 and O-1570 are commercial products of Mitsubishi-Kagaku Foods Corporation, and their melting points are as shown in Table 1. The polyglycerin esters shown in Table 1, that is, Decaglyn 1-L is a commercial product of Nikko Chemicals Co., Ltd. and DS-3 is RYOTO-polyglyester manufactured by Mitsubishi-Kagaku Foods Corporation.

The Haematococcus extract used was ASTOTS-S manufactured by Takedashiki Co., Ltd. Lecithin (derived from soybean) was Lecion P manufactured by Riken Vitamin Co., Ltd. Mixed tocopherol was Riken E Oil 800 manufactured by Riken Vitamin Co., Ltd. DHA-70 was DHA-70 manufactured by Maruha Corporation.

TABLE 2

| | | Emulsified | | | |
|---|---|---|---|---|---|
| | | particle | | | |
| | | size of re- | | | |
| | Average | dispersed | | | |
| | emulsified | emulsified | | | |
| | particle | product | | Adhesive | |
| | size (nm) | (nm) | Yield | property | Processability |
| Example 1 | 50 nm | 121 nm | 91% | A | A |
| Example 2 | 53 nm | 118 nm | 93% | A | A |
| Example 3 | 64 nm | 130 nm | 92% | A | A |
| Example 4 | 57 nm | 146 nm | 90% | A | A |
| Example 5 | 46 nm | 103 nm | 91% | A | A |
| Example 6 | 58 nm | 116 nm | 92% | A | A |
| Comparative | 52 nm | 148 nm | 48% | C | C |
| Example 1 | | | | | |
| Comparative | 65 nm | 150 nm | 28% | C | C |
| Example 2 | | | | | |
| Comparative | 118 nm | 152 nm | 57% | C | C |
| Example 3 | | | | | |

From the results in Table 2, it was revealed that any powdered compositions of the invention were produced in high yield, and the resulting powdered compositions reduced adhesion attributable to the stickiness on the powders and were excellent in processability.

When the powdered compositions of the invention were re-dispersed in an aqueous medium, emulsified products containing finely emulsified particles of 150 nm or less in particle size were obtained.

In the powdered compositions in Comparative Examples 1 and 2 wherein the emulsified emulsifier defined in the invention was not included, on the other hand, it was confirmed that the particle size of emulsified particles in their re-dispersed emulsions were relatively excellent, but the yield was low and processability was inferior. In Comparative Example 3 wherein a sucrose fatty acid ester having a melting point of less than 45° C. was used as the emulsifier in a larger amount than defined in the invention, the yield was slightly improved, but processability was inferior, and the objective finely emulsified particle size could not be obtained in the emulsion composition obtained by re-dispersion.

### Example 7

### 1. Preparation of Powdered Composition PW-1

### <1-1. Preparation of Emulsion Composition EM-1>

The emulsion composition EM-1 was prepared according to the following composition and process.

<Composition>

| (Components) | (mass %) |
|---|---|
| (1) Haematococcus alga pigment (astaxanthin content of 20% | 1.8 |
| by mass)*¹ | |
| (2) Mixed torophenol*² | 0.5 |
| (3) Sucrose lauric acid ester*³ | 1.8 |
| (4) Lauric acid polyglyceryl-10*⁴ | 1.8 |
| (5) Lecithin*⁵ | 1.8 |
| (6) Acacia gum*⁶ | 6.0 |
| (7) H₂O | 86.3 |

*¹ASTOTS-S manufactured by Takedashiki Co., Ltd.
*²Riken E Oil 800 manufactured by Riken Vitamin Co., Ltd.
*³RYOTO-sugar ester L-1695 manufactured by Mitsubishi-Kagaku Foods Corporation
*⁴NIKKOL Decaglyn 1-L manufactured by Nikko Chemicals Co., Ltd.
*⁵Lecion P manufactured by Riken Vitamin Co., Ltd.
*⁶INSTANT GUM AB manufactured by Colloid Naturel Japan

<Process>

(A) The components (1) to (2) above were weighed out in a vessel and then heated and mixed under stirring in a thermostatic bath at 70° C., and after it was confirmed that they had been well mixed, the mixture was kept at 70° C. to give a mixture A.
(B) The components (3) to (7) above were weighed out in a vessel and then heated and mixed under stirring in a thermostatic bath at 70° C., and after it was confirmed that they had been well mixed, the mixture was kept at 70° C. to give a mixture B.
(C) The mixture A was added to, and mixed with, the mixture B, and the resulting mixture was uniformly emulsified. The emulsifying device used was a homogenizer (manufactured by SMT) and stirred at 10000 rpm for 5 minutes to give a mixture C.
(D) The mixture C was emulsified with a high pressure homogenizer (Altimizer HJP-25003 manufactured by Sugino Machine Co., Ltd.) at a pressure of 235 MPa at a liquid temperature of 60° C. to give an emulsion composition EM-1.

The average particle size of the emulsion composition EM-1 was determined under the measurement condition of 25° C. with a particle size analyzer (FPAR-1000, manufactured by Otsuka Electronics Co., Ltd.) in 10 mass % solution prepared from the emulsion composition. The result indicated that the particle size was 72 nm.

### <1-2. Preparation of Powdered Composition PW-1>

The emulsion composition EM-1 obtained in 1-1 was sent at a rate of 10 mL/min. with a spray dryer (ADL310 manufactured by Yamato Kagaku Co., Ltd) and spray-dried with blowing air at 150° C. to prepare a powdered composition PW-1.

100 g of the powdered composition PW-1 obtained above was weighed out and introduced into a bag formed from a polyethylene film of 40 μm in thickness (oxygen transmission rate, 1000 mL/m²/atm/day; moisture transmission degree, 5 g/m²/day). Together with a deoxidant (trade name: Ageless E-150, manufactured by Mitsubishi Gas Chemical Co., Inc.) and 5 g of a desiccant (shown in Table 1) included in a breathable film having openings through which particles of the desiccant could not pass (synthetic fiber nonwoven fabric), the powdered composition was enclosed in a container consisting of a packaging material (oxygen transmission rate, 0.5 mL/m²/atm/day; moisture transmission degree, 0.2 g/m²/day) having a substrate film (polyethylene of 80 μm in thickness) laminated with an aluminum foil in thickness of 7 μm, a polyethylene film of 15 μm in thickness and a polyethylene terephthalate film of 12 μm in thickness, and the opening of the container was sealed by heating, whereby a packaged product was obtained.

### Example 8

A packaged product in Example 8 was obtained in the same manner as in producing the packaged product in Example 7 except that the desiccant was changed (as shown in Table 1).

### Comparative Examples 4 to 6

Packaged products in Comparative Examples 4 to 6 were obtained in the same manner as in producing the packaged product in Example 7 except that as shown in Table 1, the desiccant and the deoxidant were added or not added and their type was changed.

Each of the packaged products of the powdered compositions was stored in an atmosphere at a temperature of 40° C. for 30 days and then opened.

The powdered composition enclosed therein was observed with naked eyes and evaluated under the following criteria. The results are shown in Table 3.

### (Storage Stability 1: Occurrence of Aggregation)

The powdered compositions were observed, and those with no observed aggregates were judged as “OK”, while those with observed aggregates were judged as “NG”.

### (Storage Stability 2: Degree of Remaining Astaxanthin)

1 g of the powdered composition was dissolved in 999 g water and then measured for its spectral absorption with a spectrophotometer (ND-1000, manufactured by Nanoprop). When the absorbance at 479 nm before storage was indicated as AbO and the absorbance at 479 nm after storage was indicated as Abl, the rate of change was determined from the following equation and evaluated under the following criteria:

Rate of change (%)=(Ab0−Ab1)/Ab0×100

A: 10% or less
B: 10% (exclusive) to 20% (inclusive) (practically acceptable)
C: higher than 20%

(Particle Size of Emulsified Particles in a Re-Dispersed Emulsion Composition)

1 g of the powdered composition removed after storage from each of the packaged products in Examples 7 to 8 and Comparative Examples 4 to 6 was added to 99 g water to give an emulsion composition. The average particle size of emulsified particles in the resulting emulsion composition was determined under the measurement condition of 25° C. with a particle size analyzer (FPAR-1000, manufactured by Otsuka Electronics Co., Ltd.) in 10 mass % solution prepared from the emulsion composition. The results are also shown in Table 3 below.

TABLE 3

| | | | | | | Emulsion |
|---|---|---|---|---|---|---|
| | Packaging | | | Storage | Storage | particle |
| | material | Deoxidant | Desiccant | stability 1 | stability 2 | size (nm) |
| Example 7 | aluminum | present | silica gel | OK | A | 125 nm |
| | laminate | | | | | |
| Example 8 | aluminum | present | lime | OK | A | 123 nm |
| | laminate | | | | | |
| Comparative | aluminum | present | absent | NG | B | 430 nm |
| Example 4 | laminate | | | | | |
| Comparative | aluminum | absent | silica gel | OK | C | 126 nm |
| Example 5 | laminate | | | | | |
| Comparative | aluminum | absent | absent | NG | C | 390 nm |
| Example 6 | laminate | | | | | |

As can be seen from the results in Table 3, the packaged products of the invention did not cause aggregates in the powdered composition and were excellent in their ability to store astaxanthin as the functional oil component.

In Comparative Example 4 wherein the deoxidant only was enclosed, on the other hand, the powdered composition showed aggregation and failed to give fine emulsion particles upon re-dispersion. In Comparative Example 5 wherein the desiccant only was enclosed and in Comparative Example 6 wherein neither the deoxidant nor the desiccant was enclosed, the degree of remaining astaxanthin as the functional oil component was low, and in Comparative Example 6, fine emulsion particles could not be obtained upon re-dispersion.

According to the invention, there can be provided an powdered composition containing an oil-soluble component which contains a functional oil-soluble component, can suppress stickiness on the surface of powders upon powderization, can reduce the aggregation of the powders and the amount of the powders adhering to an apparatus in a production process, and can be produced in high yield and an powdered composition containing an oil-soluble component which contains a sufficient amount of a functional oil-soluble component and can, upon dissolution and dispersion in an aqueous medium, give an emulsified product capable of stably forming finely emulsified particles of 150 nm or less.

By using the powdered composition containing an oil-soluble component of the invention, there can be provided a functional food wherein a functional oil-soluble component is included as finely emulsified particles and is excellent in absorbability.

According to the invention, there can be also provided a packaged powdered composition wherein a powdered composition that contains an oil component containing at least one functional oil component and can, upon addition to an aqueous medium, form an emulsified dispersion can be stored for a long time stably without aggregating powders or denaturizing the functional oil component.

That is, the invention can provide the following <1> to <17>:

<1>. A powdered composition containing an oil-soluble component obtained by drying an emulsion composition containing an oil-soluble component and an emulsifier, wherein the melting point of the emulsifier is 45° C. or more, and the ratio of the emulsifier to the oil-soluble component is 0.5 to 1.5.
<2>. The powdered composition containing an oil-soluble component of item <1>, wherein the emulsifier having a melting point of 45° C. or more is included as the emulsifier at an amount of 60% by mass or more with respect to the total amount of the emulsifier.
<3>. The powdered composition containing an oil-soluble component of item <2>, wherein the emulsifier is a sucrose fatty acid ester and/or a polyglycerin fatty acid ester.
<4>. The powdered composition containing an oil-soluble component of item <1>, wherein the emulsifier comprises (b) a sucrose fatty acid ester and/or a polyglycerin fatty acid ester and (c) a phospholipid, and the ratio of (b) to (c) in the composition is established such that (b) is equal to, or higher than, (c).
<5>. The powdered composition containing an oil-soluble component of item <4>, wherein the phospholipid includes two fatty acid residues in one molecule thereof.
<6>. The powdered composition containing an oil-soluble component of item <4>, further comprising (d) an excipient.
<7>. The powdered composition containing an oil-soluble component of any one of items <1> to <6>, wherein the oil-soluble component is at least one member selected from the group consisting of carotenoids and unsaturated fatty acids.
<8>. The powdered composition containing an oil-soluble component of any one of items <1> to <7>, wherein at least one member selected from the group consisting of tocopherol, tocotrienol and derivatives thereof is further included as the oil-soluble component.
<9>. The powdered composition containing an oil-soluble component of any one of items <1> to <8>, wherein the emulsified particle size of an emulsified product obtained by dissolving and dispersing the powdered composition containing an oil-soluble component in an aqueous medium is 150 nm or less.
<10>. A functional food comprising the powdered composition containing an oil-soluble component of any one of items <1> to <9>.
<11>. The functional food of item <10>, which is in the dosage form of a drink, a capsulated product, granules or tablets.
<12>. A packaged powdered composition containing an oil-soluble component comprising the powdered composition containing an oil-soluble component of any one of items <1> to <9> enclosed in a packaging material having an oxygen transmission rate of 50 mL/m²/atm/day or less and a moisture transmission degree of 40 g/m²/day or less in the presence of a deoxidant and a desiccant.
<13>. The powdered composition containing an oil-soluble component of item <12>, wherein the packaging material is selected from the group consisting of a single-layer or multilayer resin film, a metal foil-laminated resin film and a metal-deposited film.
<14>. The packaged powdered composition containing an oil-soluble component of item <12>, wherein the powdered composition containing an oil-soluble component is enclosed in a breathable film.
<15>. The packaged powdered composition containing an oil-soluble component of item <12>, wherein the powdered composition containing an oil-soluble component satisfies:
i) the water content thereof is 0.5% to 3.0%, and
ii) the average particle size of emulsified particles in an emulsion composition obtained by converting the powdered composition into 1 mass % aqueous solution is in the range of from 1 nm to less than 130 nm.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It is intended that the scope of the invention be defined by the following claims and their equivalents.

1. A powdered composition containing an oil-soluble component, obtained by drying an emulsion composition containing an oil-soluble component and an emulsifier, wherein the melting point of the emulsifier is 45° C. or more, and the ratio of the emulsifier to the oil-soluble component is 0.5 to 1.5.

2. The powdered composition containing an oil-soluble component of claim 1, wherein the emulsifier having a melting point of 45° C. or more is included as the emulsifier at an amount of 60% by mass or more with respect to the total amount of the emulsifier.

3. The powdered composition containing an oil-soluble component of claim 2, wherein the emulsifier is a sucrose fatty acid ester and/or a polyglycerin fatty acid ester.

4. The powdered composition containing an oil-soluble component of claim 1, wherein the emulsifier comprises (b) a sucrose fatty acid ester and/or a polyglycerin fatty acid ester and (c) a phospholipid, and the ratio of (b) to (c) in the composition is established such that (b) is equal to, or higher than, (c).

5. The powdered composition containing an oil-soluble component of claim 4, wherein the phospholipid includes two fatty acid residues in one molecule thereof.

6. The powdered composition containing an oil-soluble component of claim 4, further comprising (d) an excipient.

7. The powdered composition containing an oil-soluble component of claim 1, wherein the oil-soluble component is at least one member selected from the group consisting of carotenoids and unsaturated fatty acids.

8. The powdered composition containing an oil-soluble component of claim 7, wherein at least one member selected from the group consisting of tocopherol, tocotrienol and derivatives thereof is further included as the oil-soluble component.

9. The powdered composition containing an oil-soluble component of claim 1, wherein the emulsified particle size of an emulsified product obtained by dissolving and dispersing the powdered composition containing an oil-soluble component in an aqueous medium is 150 nm or less.

10. A functional food comprising the powdered composition containing an oil-soluble component of claim 1.

11. A functional food comprising the powdered composition containing an oil-soluble component of claim 7.

12. A functional food comprising the powdered composition containing an oil-soluble component of claim 8.

13. The functional food of claim 10, which is in the dosage form of a drink, a capsulated product, granules or tablets.

14. A packaged powdered composition containing an oil-soluble component comprising the powdered composition containing an oil-soluble component of claim 1 enclosed in a packaging material having an oxygen transmission rate of 50 mL/m²/atm/day or less and a moisture transmission degree of 40 g/m²/day or less in the presence of a deoxidant and a desiccant.

15. The packaged powdered composition containing an oil-soluble component of claim 14, wherein the packaging material is selected from the group consisting of a single-layer or multilayer resin film, a metal foil-laminated resin film and a metal-deposited film.

16. The packaged powdered composition containing an oil-soluble component of claim 14, wherein the powdered composition containing an oil-soluble component is enclosed in a breathable film.

17. The packaged powdered composition containing an oil-soluble component of claim 14, wherein the powdered composition containing an oil-soluble component satisfies:
i) the water content thereof is 0.5% to 3.0%, and
ii) the average particle size of emulsified particles in an emulsion composition obtained by converting the powdered composition into 1 mass % aqueous solution is in the range of from 1 nm to less than 130 nm.
